(19) United States
(12) Patent Application Publication
(10) Pub. No.: US 2015/0213380 A1
(43) Pub. Date: Jul. 30, 2015

(54) System and Method for Dynamically Creating a Multi-Level Well Hierarchy by Integrating Data From Multiple Sources

(71) Applicant: EnergyIQ, Centennial, CO (US)

(72) Inventors: Stephen M. Cooper, Centennial, CO (US); Richard G. Prucha, Spring, TX (US)

(21) Appl. No.: 14/610,998

(22) Filed: Jan. 30, 2015

Related U.S. Application Data
(60) Provisional application No. 61/933,392, filed on Jan. 30, 2014.

(51) Int. Cl. G06Q 10/06; G06Q 50/06; G06F 17/30

(52) U.S. Cl. CPC G06Q 10/06; G06F 17/30289; G06F 17/30424; G06Q 50/06

(57) ABSTRACT

The present invention relates to the collection, storage, and management of global oil and gas well information obtained from multiple well data sources. In some embodiments, the invention relates to the assembly and use of a multi-level hierarchical database for storing well records, where each record stored in the database is categorized by one of a low level (e.g., well event), a middle level (e.g., wellbore), or a high level (e.g., well), such that a query for a record yields a single comprehensive result record comprising all of the stored records related to the query, from all hierarchical levels and from all of the well data sources.

### CROSS REFERENCE TO RELATED APPLICATIONS

This application claims priority from U.S. Provisional Patent Application Ser. No. 61/933,392, filed Jan. 30, 2014, entitled “System and Method for Dynamically Creating a Multi-Level Well Hierarchy by Integrating Data From Multiple Sources”; the entire disclosure of which is hereby expressly incorporated by reference herein in its entirety.

### FIELD OF THE INVENTION

The present invention relates to the collection, storage, and management of global oil and gas well information obtained from multiple well data sources. The invention in particular relates to the assembly and use of a multi-level hierarchical database structure for creating and storing well records, wherein each well record stored in the database is categorized as existing at a specific level in the well hierarchy and comprised of data integrated from multiple sources, such that a query for a well record yields a single comprehensive result record at the appropriate level of the well hierarchy comprising of the most trusted data available.

### BACKGROUND OF THE INVENTION

The development of horizontal drilling and hydraulic fracturing technologies has made unconventional reserves in the U.S. profitable. The practical implementation of this technology was initially with shale gas, but high oil prices in 2011 and 2012 persuaded many companies to start active drilling of unconventional reservoirs. In 2011, the number of drilling oil rigs in the U.S. exceeded the number of gas rigs. Oil production in the Bakken formation in North Dakota increased by more than 7.5 times up to 589,000 barrels per day (“b/d”) between 2008 and 2012; over the entire U.S., unconventional production reached 1.2 million b/d. (IEA; IHS Cera, IHS Herold.)

The development of unconventional reserves has been a key factor in North America leading the global production growth rankings; it is forecast to remain in this position for the next 10 years. The aggregate volume of liquid hydrocarbon and biofuel production in the U.S. and Canada will amount to 19 million b/d by 2025, thus significantly reducing the region's dependency on oil imports. It is anticipated that 3.9 million b/d of this total will be produced from unconventional shales; primarily from the Bakken and Eagle Ford plays. It is also forecast that production growth in unconventional gas will allow the U.S. to export gas by the middle of the current decade, and become a net exporter by 2020. It is anticipated that peak production in the shale plays will be reached in 2020, with the limiting factor being the availability of rigs, crews and water for fracking (IEA; IHS Cera, IHS Herold.)

Current reserve estimations support the ability to deliver this level of production in the long-term, e.g., beyond 2040. The U.S. Department of the Interior estimates that the total volume of undiscovered, technically recoverable oil in the United States is approximately 134 billion barrels, for onshore drilling alone. In April of 2008, the United States Geological Survey released a report estimating that, using new horizontal drilling technologies, the Bakken Formation, which occupies about 200,000 square miles of land underlying portions of Montana and North Dakota, could yield up to 3.5 billion barrels of oil. This estimate was refined upwards in 2013 to 7.4 billion barrels. Continental Resources, a leading producer in the region, estimates the reserves in the region are about 20 billion barrels.

To support these levels of production in onshore unconventional plays has required the development of new, more complex drilling technologies. An ever increasing number of wells are being drilled in several stages with multiple horizontal segments that can extend over several thousands of feet. Wellbores are now being drilled and completed using multiple rigs in reduced timeframes to minimize costs and maximize efficiency. Currently, in the Bakken, it is forecast that around 7,000 new wells will be drilled in 2014 of which the vast majority will be classified as horizontal wells. In order to reach peak production by 2020, this number will increase to in excess of 30,000 wells per year. This increase in drilling activity will apply across a number of regions across the U.S. to drive up the number of wells being drilled on an annual basis.

According to current estimates, there have been in excess of 4 million wells drilled in the United States since record keeping began. Up until 10 years ago, the vast majority of these were simple vertical wells drilled and completed in conventional plays. With the development of unconventional plays, however, this has now switched to where the majority of wells being developed are horizontal wells with more and more being drilled with multi-laterals. The amount of data and the complexity of these data associated with drilling this new type of well is increasing dramatically. It is estimated that the volume of data per well has increased anywhere from 10 to 100× over the past 10 years due to the fact that companies need to track data to an ever more granular level to realize competitive advantage and stay in compliance with regulatory requirements. Large volumes of data are now being captured at multiple levels of the well hierarchy; wherein the well hierarchy is defined as the relationship between the well origin and all of the downhole components of the well including, but not limited to, wellbore, completion, contact interval, and reporting stream. The well hierarchy has been defined in detail through the Professional Petroleum Data Management (“PPDM”) Association's “What is a Well?” standards initiative. Each well and its associated wellbores, completions and other components are characterized, tracked, controlled, leased, operated, and sold based on a wide variety of data attributes. These attributes include, but are not limited to, wellbore identification names, well names, well numbers, lease numbers, well operator, region, county, state, drilling start dates, completion dates, surface and bottom locations, onshore and offshore locations, drilling status, basin, and total depth. A well and its associated wellbores, and the events associated with the wellbores, may be characterized by hundreds of different attributes.

Given the large number of wells and wellbores globally, the estimated increase in well development, the large amount of data associated with each well, and the complexity of the data being captured, there is a need for methods and systems for collecting, integrating and storing well data in a consistent and structured fashion that will allow reliable access to the stored data, and reliable and repeatable generation of reports. The challenge with developing such systems and methods are that there are numerous sources of well data, including company proprietary data, partner data, State regulatory data, and commercial providers of data including IHS, EGI, Drilling Info, and TGS. All of the different sources uses a different method for identifying well attributes, and categorizes well attributes using their own unique methods and work-flows. In addition, each of the data sources typically captures data for a different phase of the well life cycle (e.g., planning, permitting, drilling, completion, production, etc.) and, most importantly, at a different level of the well hierarchy; for example, the landman may only be concerned with the well origin during the planning phase, the reserves engineer will be concerned with the wellbores, while the drilling engineer will be concerned with completions and contact intervals.

There is tremendous competitive advantage to be gained by being able to establish a master well database with a common set of identifiers which integrates data from multiple sources at all relevant levels of the well hierarchy such that a query against the database consistently returns the best data available at the appropriate level of the well hierarchy with unambiguous results. Such a master well store can be used as the foundation for an enterprise MDM solution wherein the multi-level well identifiers can be used to link disparate systems including financial, legal, reserves accounting systems. Identification of the well completion is getting a lot more attention than previously due to the influence of shale plays and the completion factory in addition to linkage to production accounting and financial applications such as SAP.

### SUMMARY OF THE INVENTION

There is a strong movement towards identifying a well across its full well lifecycle by assigning a surrogate key and not using an API or other intelligent identifier. The question then becomes whether the surrogate key should contain any intelligence. There is no consistency in terms of adding intelligence into the surrogate key. For example, some companies have implemented a solution where there is no intelligence and they maintain relationships between the components in an XREF (i.e., cross reference) table and alternate names through an ALIAS table (in PPDM terms). This is complex and difficult to maintain over time. Other companies have essentially recreated the API construct with all hierarchical entity relationships built into the ID. This eliminates most of the benefits of moving to a surrogate key in the first place. Further, most companies have implemented a hybrid solution where there is some intelligence within the ID.

These and other needs are addressed by the various embodiments and configurations of the present invention.

It is one aspect of embodiments of the present invention to establish an integrated, multi-level, hierarchical database for storing oil and gas well records received from multiple oil and gas well data sources, in a single well master database. Specifically, it is an objective of the present invention to establish a multi-level hierarchical database for storing well records, wherein each record stored in the database has a unique, system-wide identifier and exists at a particular level within the well hierarchy with defined relationships with other associated well records, such that a query for a record yields a single comprehensive result of the best data available comprising all of the stored records related to the query, from all hierarchical levels, and from all of the well data sources.

It is another aspect of embodiments of the present invention that any solution designed is data source agnostic. In essence this means that the solution cannot be built around the data structure of a specific data source but must accommodate the structure of all data sources so that if one is removed or a new source added the solution does not break or require rework. Thus, it is one aspect of embodiments of the present invention to provide a method that will be data agnostic and will be functional with or without specific data types.

It is another aspect of embodiments of the present invention to provide a method and system where all data can be loaded with a system generated UWI as the primary key in the database well tables rather than the API number. Thus, the well cross reference and well alias tables are key in keeping track of the relationship between the well components rather than the state provided API number.

Further, one aspect of embodiments of the present invention is to provide a method where the original data will be loaded as delivered from the source at whichever level of the well hierarchy in which it is published or created. Other data may be derived from the original data, but the original copy will remain intact within the database. Thus, the original header data will be loaded into the well version table with a stub record in well as required by some embodiments.

It is another aspect of embodiments of the present invention to provide a method where blended and aggregated records will be created in the well table.

An additional aspect of embodiments of the present invention is to provide a system and method where the solution will support the creation of a base load from the source data in addition to transactional updates.

Further, it is one aspect of embodiments of the present invention to adopt industry standards, where possible and appropriate. In particular, the PPDM “What is a Well?” standards will be adopted for the definition of the well level hierarchy. The definitions around well completion are considered to be fluid at this time and so any architecture must be flexible to be able to accommodate future changes.

It is another aspect of embodiments of the present invention to implement a bottom-up versus a top-down approach to aggregation and blending. Thus, the solution will work from the lowest levels defined within the well hierarchy to create the higher levels rather than the other way around.

It is a further aspect of embodiments of the present invention to provide a system with one naming convention. Thus, a standard naming convention can be used throughout the industry.

In one embodiment of the present invention, all event level records within a wellbore will have certain characteristics in common. For instance, the following attributes in the WELL table will not vary for any event within a wellbore: UWI, CONFIDENTIAL_TYPE (e.g., PROPRIETARY_IND), COUNTRY, COUNTY, DISTRICT, GEOGRAPHIC_REGION, GEOLOGIC_PROVINCE, LEGAL_SURVEY_TYPE, PROFILE_TYPE (e.g., HOLE_DIRECTION), PROVINCE_STATE, PDEN.PDEN_ID, SURFACE_NODE_ID (may change between two different sources), WATER_DEPTH, DISTRICT_NUMBER (not in the PPDM 3.9 data model), SOURCE (not in the PPDM 3.9 data model), and DEVIATION_IND (not in the PPDM 3.9 data model). The following well attributes will vary for 14-digit events within the same wellbore: UWI and WELL_GOVERNMENT_ID (e.g., GOVT_ASSIGN_NUMBER). The remaining well attributes may vary for events within the same wellbore.

In some embodiments, with the initial pass, the aggregation rules to manufacture the wellbore and well records are primarily dependent on the earliest SPUD_DATE, latest COMPLETION_DATE, or greatest DEEPEST_DEPTH values. Various aggregation rules can be used in various embodiments.

In some embodiments, matching of aggregated PI wellbores and original wellbores from other vendors will be conducted by comparing the following attributes: WELL_GOVERNMENT_ID, STATE, COUNTY, FIELD, WELL_NAME, SPUD_DATE, SURFACE L/L, BOTTOM HOLE L/L, TOWNSHIP & DIRECTION, RANGE & DIRECTION, SECTION, COMPLETION_DATE, FIRST_PRODUCTION_DATE, DRILL_TD, FINAL_TD, and MAX_TVD.

In one embodiment, the blending system uses a configurable Source Preference List (“SPL”) hierarchy to blend 14-digit events from two or more well version sources into a single 14-digit golden record. As an example, if the most trusted source is APC and the second trusted source is PI, then all of the populated attributes from the APC record are promoted to from the WELL_VERSION table to the WELL table, and only the PI populated attributes for the same 14-digit event are promoted if the APC value is null. Thus, the SOURCE of the blended records will equal BLEND. If only one 14-digit record is available, then the original SOURCE value will be retained.

In some embodiments, blending at the wellbore level includes incorporating data from multiple sources. The blending system can be configured to use the SPL hierarchy to blend two or more 12-digit wellbores into a single 12-digit golden record. As an example, if the most trusted source is APC and the second trusted source is PI, then all of the populated attributes from the APC record are promoted to from the WELL_VERSION table to the WELL table, and only the PI populated attributes for the same 12-digit event are promoted if the APC value is null. In this case, the SOURCE for the blended records will equal BLEND. If only one wellbore record exists, then the original SOURCE value will be retained.

In one embodiment, blending at the well level is similar to that for wellbore and event levels. Multiple sources of well data are compared and the final version in the well table is created based upon an attribute-by-attribute comparison to identify and promote values with the highest priority source.

In some embodiments, the system comprises a processor, memory, an input device, a display to display content, and a power source (which can be a battery). The system can further include data storage, software, a user interface, an input device, an output device, a communication network, such as Bluetooth or WiFi, and/or a communication interface for communicating with another computing device and/or the communication network.

In further embodiments, the processor can include any processor capable of performing instructions encoded in software or firmware. Further, the processor can be provided to execute instructions contained within the memory and/or data storage. The processor can comprise a controller or application specific integrated circuit (ASIC) having or capable of performing instructions encoded in logic circuits. The memory may be used to store programs or data, including data comprising content. As examples, the memory may comprise RAM, SDRAM, or other solid state memory. Alternatively or in addition, data storage may be provided. The data storage may generally include storage for programs and data.

In one embodiment, the system comprises a database having a hierarchy and containing data organized in the hierarchy and a processor capable of performing instructions encoded in software or firmware. The processor may be coupled to the database and in communication with other databases, computing devices, and/or servers. In an additional embodiment, the system further comprises an electronic display for displaying content, a processor, memory, and a communication interface to connect to a communication network. Thus, the processor can connect to the communication network and receive additional records from other data sources, including oil and gas well data sources. Further, the processor can connect to the database and receive data, information, and records from oil and gas well data sources and transmit that data, information, and records to the database.

In one embodiment of the present invention, a method for integrating records from multiple oil and gas well data sources into a multi-level well hierarchy within a database is provided. The method comprising: a) providing a database wherein oil and gas well data are stored, wherein said database comprises multiple hierarchical levels comprising a well record at the highest level, wellbore at the next level, and any number of lower level records, wherein oil and gas well data comprise a plurality of stored records, wherein each stored record comprises at least one attribute, wherein each stored record is associated with one hierarchical level within said database, wherein each stored record at a lower level in the hierarchy inherits attributes from records at a higher level and supports additional detail, wherein records identified as a deepening event are re-classified as a wellbore, and wherein each stored record is associated with a unique identifier comprising an eight digit prefix and a three digit suffix, wherein said eight digit prefix identifies the data stored at the well level, and said three digit suffix identifies data stored at all lower levels in the well hierarchy.

In one embodiment of the present invention, the method for integrating records from multiple oil and gas well data sources further comprises the steps of: b) receiving a new record from one of the sources, wherein said new record comprises at least one attribute and said new record is associated with one of the multiple hierarchical levels of said database; c) identifying a deepening event and re-classifying this as a wellbore, wherein a deepening is defined as new ground drilled from the base of an existing wellbore; d) searching for a match for said new record, wherein a match corresponds to locating a stored record with attributes that match those of said new record based upon defined criteria; e) assigning, for each match found, the unique well identifier associated with the matched stored record to the matched new record, to create a new stored record with the same unique identifier; f) creating a new unique identifier for each new unmatched record for which a match with a stored record cannot be found, to create a new stored record; g) creating a new unique identifier and aggregated record for each level higher than said unmatched new record, to create a new stored record for each level, wherein the aggregated record is created at a higher level in the well hierarchy from one or more records at a lower level in the well hierarchy based upon business rules, each aggregated record is created from lower level records of the same source, each aggregated record has the same 8 digit prefix in the identifier as the lower level records but the next 3 digit suffix in sequence; h) repeating steps b) through g) for new records from all of the oil and gas well data sources; i) blending the new and existing stored records, wherein each blended record is combined from a different oil and gas well data source, each blended record is has the same unique identifier, and each blended record is from the same hierarchical level, to create a new blended record; and k) providing a user interface, from which a user can submit a query for a well record and receive a search record that comprises all oil and gas well data that match said query from all oil and gas well data sources.

In one embodiment of the present invention, a method for integrating records from one or more oil and gas well data sources into a multi-level well hierarchy within a database is provided. The method comprises: a) providing a database of oil and gas well data organized in hierarchical levels that include a well level, a wellbore level, and a low level, wherein the well level is higher than any other level and the wellbore level is below the well level, wherein the oil and gas well data comprise stored records associated with one of the hierarchical levels, wherein each stored record comprises an attribute, wherein each stored record at the wellbore level receives the attribute from one or more stored records at the well level, and wherein each stored record at the low level receives the attribute from one or more stored records at the wellbore level and the attribute from one or more stored records at the well level; b) identifying one of the stored records as a deepening event; c) reclassifying the stored record identified as a deepening event as a wellbore; d) providing each one of the stored records with a unique identifier including a prefix and a suffix, wherein the prefix denotes data stored at the well level and the suffix denotes data stored at one or more levels lower than the well level in the in the hierarchy; e) receiving a first new record from a first source of the one or more oil and gas well data sources, wherein the first new record comprises a first attribute, and wherein the first new record is associated with one of the hierarchical levels; f) locating a second one of the stored records that includes the first attribute, wherein the second one of the stored records includes a unique identifier; g) identifying the second one of the stored records as the first match of the first new record; h) assigning the unique identifier of the second one of the stored records to the first new record to create a new matched stored record, wherein the new matched stored record includes the unique identifier of the second one of the stored records, and wherein the new matched stored record is at a first level of the hierarchical levels; i) creating a new unique identifier for the first new record to create a new unmatched stored record, in the event a match is not located, wherein the new unmatched stored record is at the first level of the hierarchical levels; j) creating an aggregated record for one level higher than the first level, wherein the aggregated record is created from at least one of the new matched stored record and the new unmatched stored record, and wherein the at least one of the new matched stored record and the new unmatched stored record is from the first source and the aggregated record is from the first source; k) assigning a second new unique identifier to the aggregated record, wherein the second new unique identifier includes a prefix and a suffix, wherein the prefix of the second new unique identifier is the same as a prefix in the unique identifier of the new matched stored record or the new unmatched stored record, and wherein the suffix of the second new unique identifier is different than a suffix in the unique identifier of the new matched stored record or the new unmatched stored record; l) repeating steps e) through k) for each new record from each one of oil and gas well data sources; m) blending a third new record having a third unique identifier, from a second source of the one or more oil and gas well data sources, and from a second level of the hierarchical levels with a first existing stored record having the third unique identifier, from a third source of the one or more oil and gas well data sources, and from the second level of the hierarchical levels to create a blended record; and n) providing a user interface from which a user can submit a query for a well record and receive a search record comprising all oil and gas well data from all of the one or more oil and gas well data sources that match the query. In a further embodiment, wherein the unique identifier is an EKey comprising an 8-digit prefix and a 3-digit suffix. In an additional embodiment, the method further comprises providing an electronic display for displaying content, a processor, memory, and a communication interface to connect to a communication network.

In one embodiment of the present invention, a method for creating and managing a well database is provided. The method comprises: providing a database comprising a well hierarchy, wherein the well hierarchy comprises a first level, a second level, and a third level, wherein the first level is higher in the well hierarchy than the second level and the third level, and wherein the second level is higher in the well hierarchy than the third level; providing data comprising:

a first stored record having a first attribute and a first unique identifier, wherein the first stored record is a first type of data; a second stored record having a second attribute and a second unique identifier, wherein the second stored record is a second type of data; a third stored record having a third attribute and a third unique identifier, wherein the third stored record is a third type of data; a fourth stored record having the first attribute and a fourth unique identifier, wherein the fourth stored record is the second type of data; and a fifth stored record having the second attribute and a fifth unique identifier, wherein the fifth stored record is the third type of data; storing the data in the database, wherein the first type of data is stored at the first level of the well hierarchy, wherein the second type of data is stored at the second level of the well hierarchy, and wherein the third type of data is stored at the third level of the well hierarchy; providing a first oil and gas well data source and a second oil and gas well data source; receiving a first new record from the first oil and gas well data source, wherein the first new record comprises the third attribute, and wherein the first new record is the third type of data; storing the first new record at the third level of the well hierarchy; locating a stored record having the third attribute and that is the third type of data, wherein the stored record is the third stored record;

identifying the third stored record as a first match of the first new record; assigning the third unique identifier of the third stored record to the first new record to create a new matched stored record; storing the new matched stored record at the third level of the well hierarchy; receiving a second new record from the second oil and gas well data source, wherein the second new record comprises a fourth attribute, and wherein the second new record is the third type of data; storing the second new record at the third level of the well hierarchy; searching for a stored record having the fourth attribute and that is the third type of data; determining that the stored record having the fourth attribute does not exist; identifying the second new record as an unmatched record; creating a new unique identifier; assigning the new unique identifier to the second new record to create a new unmatched stored record; storing the new unmatched stored record at the third level of the well hierarchy; aggregating records from the first oil and gas well data source and of the third type of data to create a first new aggregated record of the second type of data and storing the first new aggregated record at the second level of the well hierarchy; aggregating records from the second oil and gas well data source and of the third type of data to create a second new aggregated record of the second type of data and storing the second new aggregated record at the second level of the well hierarchy; aggregating records from the first oil and gas well data source and of the second type of data to create a third new aggregated record of the first type of data and storing the third new aggregated record at the first level of the well hierarchy; and blending the first new aggregated record and the second new aggregated record to create a new blended record of the second type of data and storing the new blended record at the second level of the well hierarchy.

In one embodiment of the present invention, a method for creating and managing a well database is provided. The method comprising: providing a database comprising a well hierarchy, wherein the well hierarchy comprises multiple levels, wherein each level comprises data of one data type; providing data comprising stored records, wherein each stored record has a unique identifier and has at least one attribute, wherein each stored record is of one data type; providing one or more oil and gas well data sources; receiving new records from the one or more oil and gas well data sources, wherein each new record has at least one attribute and is of one data type; searching for stored records having attributes that are the same as attributes of the new records and that are the same types of data as the new records, wherein stored records having attributes that are the same as attributes of the new records and that are the same types of data as the new records are matches; determining whether matches exist for the new records; assigning any unmatched records new unique identifiers to create new unmatched stored records; assigning unique identifiers of matching stored record to the matching new records to create new matched stored records; storing the new unmatched stored records and the new matched stored records in the database; aggregating new unmatched stored records and new matched stored records from the same oil and gas well data source and of the same type of data to create new aggregated records, wherein the new aggregated records are of a type of data one level higher than the new unmatched stored records and new matched stored records; storing the new aggregated records in the database at the level higher than the new unmatched stored records and new matched stored records; and blending new aggregated records from different oil and gas well data sources and of the same type of data to create new blended records; and storing the new blended records at the level of the new aggregated records.

To reduce the need to provide extensive disclosure in this application, but to provide adequate written description of the various devices and methods encompassed by the numerous embodiments of the present invention, various patents and patent publications are incorporated herein in their entireties by this reference. PCT Patent Application Publication No. 2004/008348 relates to a computer data processing system including a central processing unit configured with a novel integrated computer control software system for the management of data objects including dynamic and automatic organization, linking, finding, cross-referencing, viewing and retrieval of multiple objects regardless of nature or source. The system provides underlying component architecture having an object-oriented database structure and a metadata database structure which is unique in storing only one instance of each object while linking the object to multiple collections and domains by unique metadata links for the grouping into and retrieval from any of the collections. PCT Patent Application Publication No. 2004/008348 is incorporated by reference herein in its entirety.

U.S. Patent Application Publication No. 2010/0174720 describes a method, apparatus, and system for configuring, designing, and/or implementing database tables, which provides a framework into which a remainder of database tables are developed. Also detailed is a method to develop this framework of database tables. This framework provides a platform for integrating data from multiple databases. A method is also provided for maintaining and managing master data as a single source of reference data to multiple databases that are based upon this framework. U.S. Patent Application Publication No. 2010/0174720 is incorporated by reference herein in its entirety.

U.S. Patent Application Publication No. 2006/0287890 describes, among other things, an integrated method of identifying, aggregating and making accessible information from multiple heterogeneous sources, including receiving data about an entity from a remotely located source; parsing the data using a parser specific to the remotely located source; if the entity does not have an existing unique entity identifier, assigning a unique entity identifier to the entity; associating the data with the unique entity identifier for the entity; associating a version number with the data and the unique entity identifier; storing the data and the version number in a location specific to the remotely located source; and aggregating the entity data accumulated from multiple remote sources and stored in locations specific to the remote source in a common, logical view of the entity record. U.S. Patent Application Publication No. 2006/0287890 is incorporated by reference herein in its entirety.

U.S. Pat. No. 7,917,541 describes a hierarchical tree to harvest data from data sources. The hierarchical tree includes multiple tree node entities arranged in multiple levels. In one case, leaf node entities of the hierarchical tree are used to collect data from the data sources. The hierarchical tree includes storage resources for storing the collected data. The hierarchical tree further includes computing resources for aggregating the collecting data in one or more aggregation operations and performing other processing operations. A receiving entity can selectively and independently receive parts of the collected data and aggregated data. U.S. Pat. No. 7,917,541 is incorporated by reference herein in its entirety.

U.S. Pat. No. 7,668,820 describes a longitudinal database of de-identified patient healthcare transaction data records linked by longitudinal linking tags (IDs). A new healthcare transaction data record, which may include alphanumeric identification code attributes, third party attributes and/or demographic attributes, is assigned an linking ID associated with a previous healthcare transaction data record based upon successful comparison of either a designated set of identification code attributes or a designated set of demographic attributes. The longitudinal data base is assembled by a matching process in which a new data record is compared level by level with previous healthcare transaction data records through a hierarchy of a first series of matching levels each defined by a designated set of alphanumeric identification code attributes and a second series of matching levels each defined by a designated set of attributes including demographic attributes and then assigned the ID associated with a successfully matched reference data record. U.S. Pat. No. 7,668,820 is incorporated by reference herein in its entirety.

U.S. Pat. No. 7,634,482 describes a system and method for associating data objects utilizing unique identifiers. Data objects are modeled utilizing a data object ontology. Unique identifiers for instances of each data object are calculated utilizing a selection of unique attributes of the data object ontology. Data objects from multiple data sources can be integrated utilizing the unique identifiers for each data object. U.S. Pat. No. 7,634,482 is incorporated by reference herein in its entirety.

The following additional U.S. patents are also incorporated by reference herein in their entireties: U.S. Pat. Nos. 7,953,585; 6,980,940; 7,945,488; 7,716,257; and 8,090,658.

The following additional U.S. Patent Application Publications are also incorporated by reference herein in their entireties: U.S. Patent Application Publication Nos. 2013/0232158; 2013/0166609; 2013/0151979; 2012/0130987; 2010/0257144; 2008/0208475; and 2011/926,519.

Finally, the following additional PCT Patent Application Publications are also incorporated by reference herein in their entireties: PCT Patent Application Publication Nos. 2006/083958 and 2013/120209.

It will therefore be appreciated by one of skill in the art that various features and elements described in the patents and patent applications incorporated by reference can be combined with the present features of the present invention to achieve various desired purposes.

As used herein, well components are defined per the definitions provided by the PPDM Association through the “What is a Well?” standards initiative, which is incorporated by reference herein in its entirety. Thus, a “well” refers to a proposed or actual drilled hole in the ground designed to exchange (or facilitate the exchange of) fluids between a subsurface reservoir and the surface (or another reservoir) or to enable the detection and measurement of rock properties, or any additional meaning given by the PPDM Association and those skilled in the art.

A “well set” refers to a grouping mechanism for well components used to maintain an end-to-end link through all stages of the well life cycle (planning to disposal), or any additional meaning given by the PPDM Association and those skilled in the art. A well set will contain one parent well and its components, and may also contain associated wells (and their components) drilled for the purpose of re-entry, skidding, relief or service specific to the parent well's operation. The well set can include both planned and actual wells. Well set allows a connection of all of the well components created over the life of a well, even if they do not get beyond the planning stage, or are not physically connected to the same well origin.

A “well origin” is the location on the surface of the earth or sea bed where the drill bit is planned to penetrate or does penetrate the earth to establish or rework a well, or any additional meaning given by the PPDM Association and those skilled in the art. A well has only one valid well origin at any point in time. A well origin is associated with one well, and all wellbores and other components that are part of that well. The location of a planned well origin can change or be inexact. Once the drill bit hits the ground, the location is fixed. A new well gets a new well origin.

A “wellbore” is a path of drilled footage, from the well origin (top/start) to a terminating point (bottom/end), or any additional meaning given by the PPDM Association and those skilled in the art. Wellbores do not need to be drilled in one continuous operation; they are defined as a path from the well origin to a terminating point. There are one or more wellbores in a planned or drilled well, namely the original wellbore, and a wellbore for each intended, actual or accidental sidetrack. Each wellbore has a unique terminating point. A deepening of an existing wellbore is considered a new wellbore with the same well origin. Note that in this case, the original terminating point will be located within the new wellbore. Widening of an existing wellbore does not constitute a new, separate wellbore.

A “wellbore segment” is a unique drilled interval within the well, either the original wellbore from the well origin to the terminating point, or additional footage from a point in an existing wellbore to a new terminating point, or any additional meaning given by the PPDM Association and those skilled in the art. A wellbore segment is a unique drilled interval, with no overlap. Every point in a well is in one and only one wellbore segment. A wellbore segment is generally drilled in one continuous operation. The starting point of a new wellbore segment is a point in an existing wellbore from which additional footage is drilled. This point may be a kickoff or sidetrack point or the original terminating point of the original wellbore, as in a deepening. The total drilled footage in a well is the sum of all the wellbore segment lengths.

A “wellbore completion” is a set of one or more wellbore contact intervals that function as a unit to produce or inject fluids, or any additional meaning given by the PPDM Association and those skilled in the art. A wellbore completion is capable of isolating a fluid flow for continuous measurement. A wellbore completion is not an activity or a state but a physical configuration. A well may have zero, one or more wellbore completions. A wellbore completion can span multiple wellbores or wellbore segments. A wellbore completion may span multiple reservoirs, and a single reservoir may exchange fluids with multiple wellbore completions. A wellbore completion is also commonly referred to as a wellbore event

A “wellbore contact interval” is a measured depth range within a wellbore that is intended to put the wellbore into contact with one or more stratigraphic zones for the purpose of production, injection or service, or any additional meaning given by the PPDM Association and those skilled in the art. A wellbore contact interval is created by a sequence of actions including (but not limited to) completion, recompletion, perforation or frack jobs. Perforation intervals, open-hole intervals, slotted-liner intervals, (or a combination of thereof) are examples of wellbore contact intervals. Unlike a wellbore completion, an individual wellbore contact interval need not be capable of isolating fluid flow. A wellbore contact interval is contained in only one wellbore completion at any point in time, although it might be contained in different wellbore completions over the life of the wellbore contact interval. A wellbore contact interval must not be associated with more than one wellbore completion at any one time but may exist, at least temporarily, without a wellbore completion. The life of a wellbore contact interval may be shorter than the entire life of a wellbore.

A “wellhead stream” is a flow of fluids through a conduit determined by an installed wellhead configuration, or any additional meaning given by the PPDM Association and those skilled in the art. The wellhead stream represents what is coming in or out of the ground at the wellhead. A wellhead is the equipment used to maintain surface control of a well. A well can have zero, one or more wellhead streams. A wellhead stream conducts fluids to or from one or more wellbore completions.

A “well reporting stream” is a derived stream of fluids to support the allocation and aggregation of volumes, or any additional meaning given by the PPDM Association and those skilled in the art. Well reporting streams may be measured, estimated or calculated. Any well component or group of well components (including other well reporting streams) can be associated with a well reporting stream.

The definitions of other well related terminology, as used herein, are per the PPDM glossary (located at http://www.ppdm.org/wiki/index.php/Category:Glossary), which is incorporated by reference herein in its entirety.

“Data” refers to facts or information used to calculate, analyze, or plan something, or any additional meaning given by the PPDM Association and those skilled in the art. As used herein data may comprise at least one of the following data types: primitive types, composite types, abstract data types, and combinations thereof. Primitive data types include, but are not limited to, Boolean, character values, real numbers, integer values, enumerated types, and combinations thereof. Composite data types include, but are not limited to, arrays, records, unions, tagged unions, and combinations thereof. Abstract data types include, but are not limited to, containers, map/associative array/dictionary, multimaps, lists, sets, multisets, priority queues, queues, deques, stacks, strings, trees, graphs, and combinations thereof.

A “record” refers to a set of attributes, typically in fixed number and sequence and typically indexed by a unique identifier, or any additional meaning given by the PPDM Association and those skilled in the art. As used herein, a “record type” is a data type that describes such values and variables. In some embodiments of the present invention, a programmer may define the record types, such that the definitions may include specifying the data type of each attribute and an identifier (name or label) by which it can be accessed. Records may exist in any storage medium, including main memory and mass storage devices such as magnetic tapes or hard disks. In some embodiments of the present invention, well records may comprise surface location information (country, state, county, latitude, longitude), legal location information (township, range, section, spot code, footage calls), operator, target formation. In some embodiments of the present invention, wellbore records may comprise spud date, completion date, rig release date, total depth, bottom hole location (latitude, longitude). In some embodiments of the present invention, completion event records may comprise base depth, base formation, top depth, top formation, perforation interval.

An “attribute” refers any value stored within a record, or any additional meaning given by the PPDM Association and those skilled in the art. In some embodiments of the present invention, well record attributes may comprise surface location information (country, state, county, latitude, longitude), legal location information (township, range, section, spot code, footage calls), operator, target formation. In some embodiments of the present invention, wellbore record attributes may comprise spud date, completion date, rig release date, total depth, bottom hole location (latitude, longitude). In some embodiments of the present invention, completion event record attributes may comprise base depth, base formation, top depth, top formation, perforation interval.

A “database” refers to an organized collection of data, or any additional meaning given by the PPDM Association and those skilled in the art. In some embodiments of the present invention, a database may comprise a general-purpose database management system (“DBMS”) including at least one of Microsoft SQL Server and Oracle. Some embodiments of the present invention, the database may comprise application software for accessing the database on behalf of end-users, utilizing a web interface, an application programming interface, or both. In further embodiments of the present invention, a database may comprise at least one of the following database types: in-memory database, cloud database, data warehouse, distributed database, federated database, mobile database, operational real-time database, unstructured database, and combinations thereof.

In some embodiments of the present invention, a database may be constructed using at least one of the following database languages: data definition language, data manipulation language, query language, and combinations thereof. Further embodiments of the present invention may comprise a database constructed using at least one of the following database languages: SQL, and SQL/XML. Further embodiments may also include at least one feature such as DBMS-specific configuration and storage engine management; computations to modify query results, like counting, summing, averaging, sorting, grouping, and cross-referencing; constraint enforcement; an application programming interface version of the query language, for programmer convenience.

As used herein, a “hierarchical database” and a “hierarchical database model” refer to a data model in which the data is organized into a tree-like structure. The structure allows representing information using parent/child relationships: each parent can have many children, but each child has only one parent (also known as a 1-to-many relationship). All attributes of a specific record are listed under an entity type. A hierarchical database facilitates hierarchical search queries. In some embodiments of the present invention a database may comprise multiple hierarchical levels comprising well records at the highest level, wellbore records at the next level, and any number of lower level records.

In some embodiments of the present invention, a multi-level well hierarchy within a database may comprise at least two levels. In further embodiments of the present invention, a multi-level well hierarchy within a database may comprise at least three levels. In still further embodiments of the present invention, a multi-level well hierarchy within a database may comprise more than three levels.

In some embodiments of the present invention, a plurality of stored records may comprise more than one record, or more than 10 records, or more than 100 records, or more than 1,000 records, or more than 10,000, records, or more than 100,000 records, or more than 1,000,000 records, or more than 10,000,000 records, or more than 100,000,000 records, or more than 1,000,000,000 records, or more than 10,000,000,000 records, or more than 100,000,000,000 records, or more than one billion records.

As used herein, the term “associated with” refers to either an automated or manual procedure for assigning a particular data set, record, value, or attribute to a specific level within the multi-level well hierarchy. In some embodiments of the present invention, data sets, records, values, attributes, etc. are associated with specific levels manually, wherein a human being defines or specifies the associations. In some embodiments of the present invention, data sets, records, values, attributes, etc. are associated with specific levels automatically, wherein a computer defines or specifies the associations, based on high level guidelines provided by a human being. As used herein, the term “re-classified” is synonymous with “associating”, but for situations where a data set, record, value, or attribute has already been associated at least once, and is being associated again.

In some embodiments of the present invention, a multi-level well hierarchy may comprise a tree structure. A tree structure is a way of representing the hierarchical nature of a structure in a graphical form. It is named a “tree structure” because the classic representation resembles a tree, even though the chart is generally upside down compared to an actual tree, with the “root” at the top and the “leaves” at the bottom. The tree elements are called “nodes”. The lines connecting elements are called “branches”. Nodes without children are called leaf nodes, “end-nodes”, or “leaves”. Every finite tree structure has a member that has no superior. This member is called the “root” or root node. The root is the starting node. But the converse is not true: infinite tree structures may or may not have a root node. The names of relationships between nodes are modeled after family relations. The gender-neutral names “parent” and “child” have largely displaced the older “father” and “son” terminology, although the term “uncle” is still used for other nodes at the same level as the parent. A node's “parent” is a node one step higher in the hierarchy (i.e., closer to the root node) and lying on the same branch. “Sibling” (“brother” or “sister”) nodes share the same parent node. A node's “uncles” are siblings of that node's parent. A node that is connected to all lower-level nodes is called an “ancestor”. The connected lower-level nodes are “descendants” of the ancestor node. Thus, in some embodiments of the present invention, all well records at the event level are descendants from a next higher wellbore level record, which in turn, is a descendant from a highest well level record. In other words, all event level records have both wellbore level and well level parents; all wellbore records have well level parents; not all well records have wellbore level children; not all wellbore records have event level children. A well level event record may have more than one wellbore level record, and a wellbore level record may have more than one event level record. Alternatively, a well level event record may have no wellbore level records, and a wellbore level record may have no event level records.

As used herein, the phrase “inherits” refers to a record at a lower level receiving the attributes associated with its higher level descendants. By way of example only, an event level record (e.g., a completion event), has a parent wellbore level record. So, any event level record that is provided to the database, that is received without the records associated with its higher level descendents, will be provided or “inherit” these records. Similarly, by way of example only, a wellbore level record (e.g., a geographic location), has a parent well level record. So, any wellbore level record that is provided to the database, that is received without the records associated with its higher level well descendent, will be provided or “inherit” these records.

As used herein, the term “aggregation” refers to the process by which a record at a higher level in the well hierarchy is created from one or more records of the same source at a lower level in the well hierarchy.

As used herein, the term “blending” refers to the process by which a record is created from one or more records at the same level in the well hierarchy from one or more records from a different source.

As used herein, the term “deepening” includes new ground drilled from the base of an existing wellbore and any additional meaning given to “deepening” in the oil and gas field.

In some embodiments of the present invention, a database may comprise at least one of the following: a PPDM 3.7 or PPDM 3.8 or PPDM 3.9 (future) database schema. The Public Petroleum Data Model (PPDM) is a de-facto industry standard database that has been in active use for over 20 years. The current version of the data model is 3.8 while there are still a number of active clients on the 3.7 data model.

In some embodiments of the present invention, an oil and gas well data source may comprise at least one of commercial data sources including IHS (i.e., Information Handling Services), EGI (i.e., Energy Graphics), DI (i.e., Drilling Info), or TGS, as well as State data sources, partner data, service provider data (such as Schlumberger or Halliburton), and company proprietary data and combinations thereof.

As used herein, a “unique identifier” refers to a distinct, singular, or one-of-a-kind alphanumeric string. In some embodiments of the present invention, records are assigned unique identifiers according to their position within the well hierarchy. In still further embodiments of the present invention, each well and well component may be assigned a system generated surrogate key, or EKey. The EKey may be comprised of two parts, a sequential number to identify the well (surface location) and an additional 3 digit number to identify all of the components of the well according to PPDM definitions. The first part of the EKey may be a system generated unique 8 digit number starting at 1,000,000 to avoid stripping leading 0's. The second part of the EKey may be a 3 digit sequential number (starting at 000) that identifies a component of the well (wellbore, completion, contact interval, etc). In some further embodiments, a recompletion or a deepening may be considered to be a component of the well even though not specifically identified as such by PPDM definitions. In still further embodiments, beyond the fact that it identifies a component of a well, there is no implied intelligence in the 3 digit sequential number of an EKey. Neither the value nor the order of the number should be interpreted as having any significance.

As used herein, “searching for a match” refers to an automated search for stored records with attributes existing in the database that are identical or within acceptable tolerances to the attributes of the records being received. For example, a new well record may be received by the database that contains a set of attributes that describe the precise geographic location of a wellbore, in addition to a collection of other wellbore level attributes. In the present invention, the database will contain the functionality needed to search its stored records, in an attempt to find any records where the geographic location attributes provide a match for the new well record. To accomplish this task, for this specific example, the database will search all stored wellbore level attributes. If the database finds, for example, a stored record that has the same precise geographic location or one within the defined tolerance, a successful match has been found. As this particular record is already stored in the database, it by definition must have a unique identifier associated with it. So, the database then assigns this unique identifier to the newly received record related to the same wellbore.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein, “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together.

Unless otherwise indicated, all numbers expressing quantities, dimensions, conditions, and so forth used in the specification and claims are to be understood as being modified in all instances by the term “about”.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

Words written in all capital letters can refer to specific acronyms; specific components, inputs, and/or fields; and/or general components, inputs, and/or fields. Thus, in some cases the word written in all capital letters is interchangeable with the same word written in lower case letters.

It shall be understood that the term “means” as used herein shall be given its broadest possible interpretation in accordance with 35 U.S.C. Section 112(f). Accordingly, a claim incorporating the term “means” shall cover all structures, materials, or acts set forth herein, and all of the equivalents thereof. Further, the structures, materials, or acts and the equivalents thereof shall include all those described in the summary of the invention, brief description of the drawings, detailed description, abstract, and claims themselves.

These and other advantages will be apparent from the disclosure of the invention(s) contained herein. The above-described embodiments, objectives, and configurations are neither complete nor exhaustive. The Summary of the Invention is neither intended nor should it be construed as being representative of the full extent and scope of the present invention. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description and no limitation as to the scope of the present invention is intended by either the inclusion or non-inclusion of elements, components, etc. in this Summary of the Invention. Additional aspects of the present invention will become more readily apparent from the Detailed Description, particularly when taken together with the drawings.

One will appreciate that this Summary of the Invention is not intended to be all encompassing and that the scope of the invention nor its various embodiments, let alone the most important ones, are necessarily encompassed by the above description. One of skill in the art will appreciate that the entire disclosure, as well as the incorporated references, pictures, etc. will provide a basis for the scope of the present invention as it may be claimed now and in future applications. The preceding is a simplified summary to provide an initial understanding of the aspects, embodiments and configurations disclosed herein. This summary is neither an extensive nor exhaustive overview of the aspects, embodiments, or configurations. It is intended neither to identify key or critical elements, nor to delineate the scope of the aspects, embodiments, or configurations but to present selected concepts in a simplified form as an introduction to the more detailed description presented below. As will be appreciated, other aspects, embodiments, and configurations are possible utilizing, alone or in combination, one or more of the features set forth above or described in detail below.

### BRIEF DESCRIPTION OF THE DRAWINGS

Those of skill in the art will recognize that the following description is merely illustrative of the principles of the invention, which may be applied in various ways to provide many different alternative embodiments. This description is made for illustrating the general principles of the teachings of this invention and is not meant to limit the inventive concepts disclosed herein.

The accompanying drawings, which are incorporated in and constitute a part of the specification, illustrate embodiments of the invention and together with the general description of the invention given above and the detailed description of the drawings given below, serve to explain the principles of the invention.

FIG. 1 illustrates data processing steps in one embodiment of a method or system for acquiring, assigning, aggregating, and blending well data from multiple data sources.

FIG. 2 illustrates data processing steps in a second embodiment of a method or system for acquiring, assigning, aggregating, and blending well data from multiple data sources.

FIG. 3 illustrates the database architecture involved in some embodiments of a method or system for acquiring, assigning, aggregating, and blending well data from multiple data sources.

FIG. 4 illustrates an embodiment of a method or system for acquiring, assigning, aggregating, and blending well data from multiple data sources.

FIG. 5 illustrates a database system according to one embodiment of a method or system for acquiring, assigning, aggregating, and blending well data from multiple data sources.

It should be understood that the drawings are not necessarily to scale, and various dimensions may be altered. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

Embodiments of the present invention relate to the collection, storage, and management of global oil and gas well information obtained from multiple well data sources. In particular, the invention relates to the assembly and use of a multi-level hierarchical database for storing well records, where each record stored in the database has a unique, system-wide identifier and exists at a particular level within the well hierarchy with defined relationships with other associated well records, such that a query for a record yields a single comprehensive result of the best data available comprising all of the stored records related to the query, from all hierarchical levels, and from all of the well data sources.

As described above, globally there are many active wells, each with a dynamic life-cycle during which, for example, new wellbores may be drilled and completions executed. As a result, new data are constantly being generated that describe the changing global population of wells, and these data need to be inputted into the database. In some embodiments of the present invention, data sources may deliver data manually and/or automatically at a defined frequency (e.g., every hour, every day, every week, once a month, etc.) such that the data are received by database. In some embodiments of the present invention, the database may receive data from multiple oil and gas well data sources sequentially or in parallel (simultaneously). In some further embodiments of the present invention, the database may receive data comprising records, wherein each record comprises attributes from only one level of database's multi-level well hierarchy. In still further embodiments of the present invention, the database may receive records containing more than one attribute, wherein the more than one attribute may be from different hierarchical levels.

In some embodiments of the present invention, attributes to be used for matching may include: a well identification number, the state in which the well is located, the county in which the well is located, and/or the field in which the well is located. Additional attributes used for matching may include, but are not limited to, the name of the well, the date that the well was initially drilled (i.e., spud date), the surface location (e.g., latitude/longitude coordinate pair), bottom hole location (e.g., latitude/longitude coordinate pair), legal location data (e.g., township, range, section, and direction), the date that the well was completed for production, the date that production was first recorded, and the total depth of the well in terms of measured depth and/or maximum vertical depth.

The matching process should be able to accommodate tolerances. For example, in one embodiment with data or information regarding a location or depth, it is possible to establish a range (e.g., 10 feet) or assign a percentage value range based upon how close the two data points match. In other embodiments, it would be difficult to establish a tolerance. The government identifier, for example, either matches or does not match and there is no in between. The final score assigned to a match between two wellbores will determine whether or not they are actually a match based upon established thresholds. Where two records are identified as matching, they will be assigned the same surrogate key (also referred to as an “EKey”), e.g., 1000124-000. This will be stored in the well alias table to ensure that the relationship is maintained for historical reference and also to be able to link back to the child records. Records that are unmatched will be assigned a new EKey and this will also be stored in the well alias table.

Every original unique well identifier (“UWI”) that is assigned an EKey will have a corresponding entry in the well alias table. It is sometimes desired to identify a well across the full well lifecycle by assigning an EKey to the well and the components of a well. The terms EKey and UWI are often used interchangeably. However, typically the term EKey refers to the system generated well identifier and UWI refers to the original source well identifier, which may be a 12-digit UWI (also called an “API” or “API number”).

The following approach to generating well identifiers is adopted for some embodiments of the present invention: each well and well component will be assigned a system generated surrogate key. The EKey will be comprised of two parts, a sequential number to identify the well origin (surface location) and an additional 3 digit number to identify all of the components of the Well according to the PPDM “What is a Well?” definition. The WELL_LEVEL_TYPE attribute in the WELL table will be used to identify the well component. The WELL_XREF table will be used to track relationships between the components. The first part of the EKey will be a system generated unique 8 digit number starting at 1,000,000 to avoid stripping leading 0's. An example of this approach is shown in Table 1 below.

TABLE 1
Surrogate Key

| EKey | WELL_LEVEL_TYPE |
|---|---|
| 1000123 | WELL |
| 1000123-000 | WELLBORE |
| 1000123-001 | WELLBORE |
| 1000123-002 | COMPLETION |
| 1000123-003 | WELLBORE |
| 100123-004 | COMPLETION |

Note that, where WELL_LEVEL_TYPE=WELL, there will not be a 3 digit well component extension. Further, the second part of the EKey will be a 3 digit sequential number (starting at 000) that identifies a component of the well (e.g., wellbore, completion, perforation etc). Note that a recompletion or a deepening should be considered to be a component of the well even though not specifically identified as such within the PPDM initiative.

Deepenings should be identified as wellbores according to the PPDM “What is a Well?” standard. However, in the IHS data structure, deepenings are assigned a 14-digit API. For this initiative, we need to be able to identify a deepening and assign it a unique well identifier. Thus, deepenings would be assigned a new 70-series API number and any subsequent 14-digit events would be assigned the same 70-series identifier. The relationship between the new wellbore ID and the original event ID needs to be maintained within the Well Alias table for reference purposes.

The Source Preference List (“SPL”) indicates the priority with which attributes are promoted to the blended record. Thus, the SPL determines which source would take priority over the other sources. Table 2 is one example of an SPL, which shows that any populated attributes in a record with a source of APC (for this specific example) would take priority over all other sources.

TABLE 2
Source Preference List
SPL

APC
WV
PI
DI
STATE

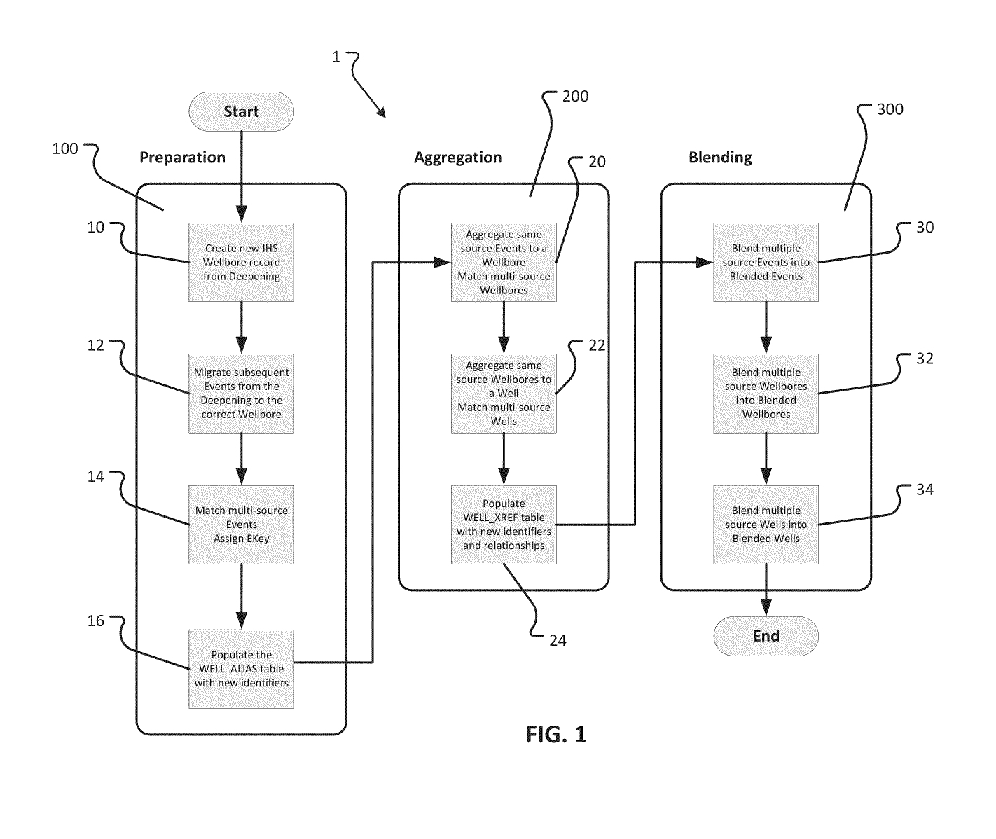

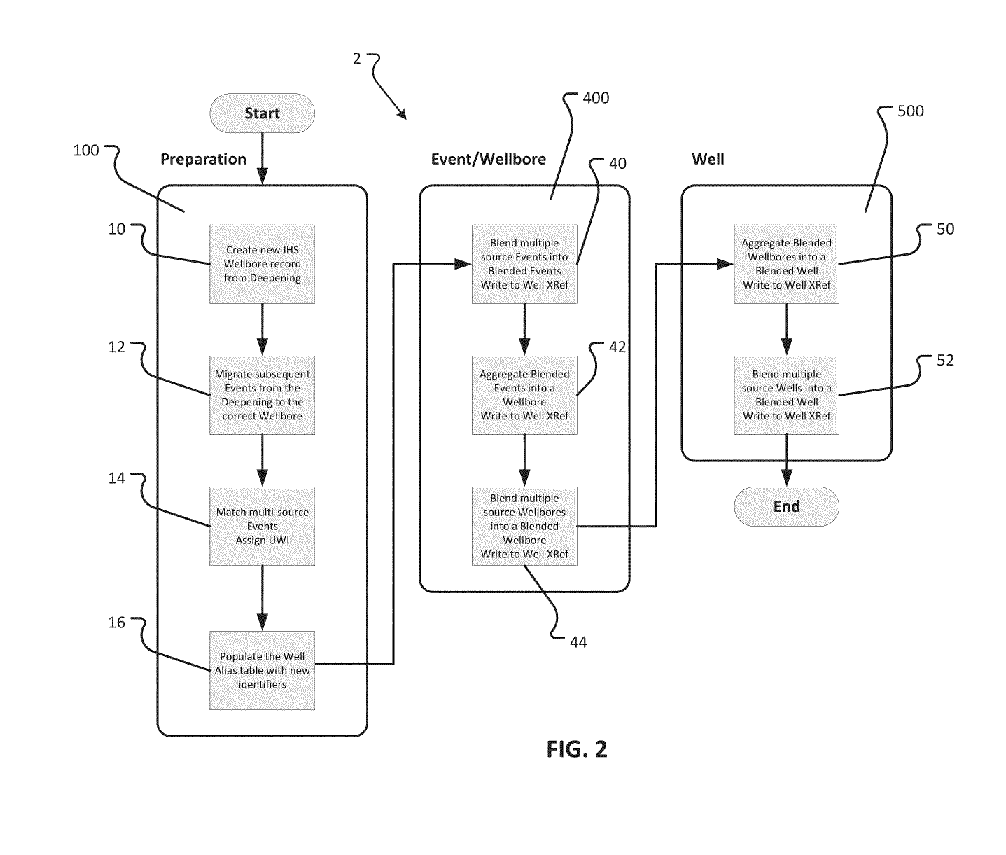

Turning now to FIGS. 1 and 2, there are two primary processes involved in the workflow to create a single version of records at each level of the well hierarchy: namely aggregation and blending. FIG. 1 shows one embodiment of the Aggregation Method 1 and FIG. 2 shows another embodiment of the Blending Method 2. Aggregation involves the generation of a record at a higher level in the well hierarchy from one or more records of the same source at a lower level. Well blending involves the consolidation of multiple records of different sources at the same level in the well hierarchy. In some embodiments of the present invention, a bottom-up versus a top-down approach to aggregation and blending may be used. Thus, the solution will work from the lowest levels defined within the well hierarchy to create the higher levels.

In some embodiments of the present invention, aggregation of records may be used, where aggregation is the process of creating a record at a higher level in the well hierarchy from one or more records at a lower level. The following rules can be used for aggregation:

Records can only be aggregated from one level in the well hierarchy to the level immediately above, e.g., Event→Wellbore, Wellbore→Well. It is not possible to aggregate backwards. It is not possible to skip a level.

Aggregation combines same source records only; it does not take place between records of a different source.

Multiple records from the same source are aggregated together using a set of business rules to define which attributes are selected from which source record.

Aggregation preferably takes place before blending to ensure that the combined process promotes the correct set of attributes and that it is possible to trace back to where the source record came from during aggregation.

Aggregated records are not created for the lowest level in the hierarchy for which data exists, but are created for all higher level records.

Relationships between aggregated records and their component source records are maintained.

If aggregating a given source would result in an aggregated record for which there already exists the same original source at the higher level, the aggregated record is not created.

The source attribute will be the same for component records and for the corresponding aggregated record.

In some embodiments of the present invention, records may be blended, wherein blending is the process of creating a single record at the same level in the well hierarchy from one or more records of different source values. The following rules may be used for blending:

Blending can only occur for records at the same level within the well hierarchy

Blending occurs with records of a different source

Multiple different source records are blended together using an SPL that establishes a priority order for the source records.

Blended records can be created at all levels in the well hierarchy

Blending is the final process in the workflow and blended records are not used in any subsequent blending or aggregation processes.

Relationships between the final blended records and their component source records are not be maintained within the well XRef table. On examination, it was determined that this relationship can be determined from records in the well version and the well tables.

If only a single source record exists at a given WELL_LEVEL_TYPE for a given surrogate key then no blending actually takes place; the single source record is retained “as is” for that level and the source value is not changed.

If two or more sources exist at a given WELL_LEVEL_TYPE for a given surrogate key, then the manufactured blended record source will be set to BLEND.

For each workflow—Aggregation Method 1 (FIG. 1) and Blending Method 2 (FIG. 2)—there is a preparation phase 100 that includes four steps. Since this process (preparation 100) is common to both workflows (i.e., the Aggregation Method 1 and the Blending Method 2), it is described in conjunction with both FIG. 1 and FIG. 2. Additionally, the following section discusses the steps that must be followed to create the master wellbore database that fully blends global data from multiple data sources. The architectural options for actually implementing this workflow are discussed later.

The first step 10 of the preparation phase 100 is to identify 14-digit records from a source (which may be IHS) that should be more correctly identified as a deepening. Thus, the first step 10 includes creating a new IHS wellbore record from the deepening records to establish the multi-level well hierarchy. The first step 10 also involves identifying IHS or another source's deepening records. For example, IHS delivers U.S. data with a 14-digit API number (i.e., an event). A number sequence other than 00 in the 13^{th} and 14^{th} digits indicates one of three events on the original wellbore: a recompletion, a deepening, or a redrill. In order to follow the PPDM “What is a Well?” convention, we need to be able to identify the 14-digit wellbore deepening events and present them as a wellbore record with a 12-digit, 70-series API number. A 70-series number means that the second-to-last digit in the number ends is 7; thus, the end of the number is 70 to 79. In addition, any 14-digit events that occur subsequent to the deepening need to be blended with the 14-digit deepening record to create the final 12-digit record.

In the example illustrated in Table 3, the third event in the sequence as determined by the completion date is a deepening of the original wellbore. In the master wellbore table, therefore, two records will be created: the 00 wellbore and the 70-series wellbore, which are both tied to the same well origin.

TABLE 3

| | Completion | | |
|---|---|---|---|
| 14-digit API | Date | Event | 12-Digit API |
| 05123123580000 | Jun. 18, 1985 | NEW | 051231235800 |
| 05123123580001 | Feb. 19, 1992 | RECOMPLETION | |
| 05123123580002 | Jul. 15, 1998 | DEEPENING | 051231235870 |
| 05123123580003 | Jul. 20, 1998 | RECOMPLETION | |
| 05123123580004 | Mar. 28, 1999 | RECOMPLETION | |

The next step 12 is where subsequent events are migrated from the deepening records to the correct wellbore and a wellbore identifier is assigned as a 70-series API number. Any subsequent events on the deepened wellbore must then be assigned to the modified wellbore API.

Attributes from the two 14-digit API records ending in 00 and 01 will be aggregated to form the 12-digit 00 wellbore (API number ends in 00). Attributes from the three 14-digit API records ending in 02, 03, and 04 will be aggregated to form the 12-digit 70-series wellbore. Converting the 14-digit API into a 12-digit API is a key part of building out the well hierarchy. A 14-digit number represents a completion event, while a 12-digit number represents a wellbore. IHS only delivers 14-digit numbers; therefore, the 12-digit wellbore number must be created in order to build out the well hierarchy through the aggregation process.

Additionally, XRef records need to be created at this stage to identify which 14-digit wellbores were aggregated to generate the 12-digit wellbore. This is required to be able to query for the child records that roll up to the wellbore in the event that they remain linked to the original completion event within the database.

Next, step 14, match multi-source events and assign a UWI, is performed. Matching across sources at different levels within the well hierarchy is a process that is repeated throughout the different workflows. At this stage in the workflow, there are multiple wellbore records from a number of different sources. Thus, we need to match the wellbores to determine which of them identify a common wellbore. Initially, the matching may be based upon the 12-digit well government ID. Eventually, however, the matching can be based upon a comparison of the attributes between the different wellbores. The attributes to be used for matching may include: WELL_GOVERNMENT_ID, STATE, COUNTY, FIELD, WELL_NAME, SPUD_DATE, SURFACE L/L, BOTTOM HOLE L/L, TOWNSHIP & DIRECTION, RANGE & DIRECTION, SECTION, COMPLETION_DATE, FIRST_PRODUCTION_DATE, DRILL_TD, FINAL_TD, or MAX_TVD.

Further, where two records are identified as matching, they will be assigned the same EKey, for example, 1000124-000. This will be stored in the well alias table to ensure that the relationship is maintained for historical reference and also to be able to link back to the child records. Records that are unmatched will be assigned an EKey and this will also be stored in the well alias table.

Step 14 is in alignment with adopting a bottoms-up approach versus top-down approach. Part of step 14 includes assigning a surrogate key to each well, wellbore, and event so that the surrogate key can be used for matching across multiple data sources. An EKey should be assigned at the lowest level in the well hierarchy and rolled up to higher levels through parent records in the hierarchy.

To be able to assign an EKey correctly at each level in the well hierarchy, it is necessary to match records across different sources. Thus, matching records are assigned the same EKey according to the structure defined previously. Table 4 below illustrates the process of assigning a new EKey to a group of 14-digit completion events where the events have been matched across multiple sources. In the example shown in Table 4, all of the completion events have the same well parent, but some are associated with different wellbores while some are an exact match at the completion event level. Examples of events include a deepening, recompletion, and work-over. Note that the examples shown herein use only three levels in the well hierarchy. However, there is no limit on the number of levels or the names of the levels in the well hierarchy. On example of an implantation with more than three levels is where the well hierarchy has the following levels, from the highest level to the lowest level: WELL, WELLBORE, WELLBORE_STAGE, EVENT, and REPORTING_STREAM.

TABLE 4

| Original UWI (API) | Ekey | SOURCE | LEVEL |
|---|---|---|---|
| 12-123-12345-00-00 | 10001234-000 | STATE | EVENT |
| 12-123-12345-00-00 | 10001234-000 | APC | EVENT |
| 12-123-12345-00-00 | 10001234-000 | PI | EVENT |
| 12-123-12345-00-01 | 10001234-001 | PI | EVENT |
| 12-123-12345-01-00 | 10001234-002 | APC | EVENT |
| 12-123-12345-01-01 * | 10001234-003 | APC | EVENT |
| 12-123-12345-01-02 * | 10001234-004 | APC | EVENT |
| 12-123-12345-01-00 | 10001234-002 | PI | EVENT |

This step 14 is preferably completed prior to the aggregation process in order to be able to assign the correct EKey to the aggregated wellbores and wells.

The next step 16 is to populate the well alias table. A link between the original UWI and the EKey will be maintained within the well alias table for cross-reference purposes. While the original UWI will typically be the API number and stored in the WELL_GOVERNMENT_ID field, this is not guaranteed to be the case and so the cross-referenced values should be recorded for consistency and reliability. See Table 5 below.

TABLE 5
Well Alias

| UWI (Skey) | Source | Alias ID | Alias Type | Alias Full Name |
|---|---|---|---|---|
| 10001234-000 | STATE | 1 | ORIGINAL UWI | 12-123-12345-00-00 |
| 10001234-000 | APC | 1 | ORIGINAL UWI | 12-123-12345-00-00 |
| 10001234-000 | PI | 1 | ORIGINAL UWI | 12-123-12345-00-02 |
| 10001234-001 | PI | 1 | ORIGINAL UWI | 12-123-12345-00-01 |
| 10001234-002 | APC | 1 | ORIGINAL UWI | 12-123-12345-01-00 |
| 10001234-002 | PI | 1 | ORIGINAL UWI | 12-123-12345-01-00 |
| 10001234-003 | APC | 1 | ORIGINAL UWI | 12-123-12345-01-01 |
| 10001234-004 | APC | 1 | ORIGINAL UWI | 12-123-12345-01-02 |
| 10001234-005 | APC | 1 | ORIGINAL UWI | 12-123-12345-00 |
| 10001234-005 | WV | 1 | ORIGINAL UWI | 12-123-12345-00 |
| 10001234-006 | WV | 1 | ORIGINAL UWI | 12-123-12345-01 |
| 10001234 | APC ** | 1 | ORIGINAL UWI | 12-123-12345 * |
| 10001234 | DI | 1 | ORIGINAL UWI | 12-123-12345 |

Referring now to FIG. 1, one embodiment of the process for creating the multi-level well hierarchy is illustrated. Following the start step, the Aggregation Method 1 starts with preparation 100, which involves identifying deepening records, matching, and assigning an EKey to the records. Next aggregation 200 is preformed at different levels in the hierarchy. Then blending 300 occurs to create the most trusted version of the data for consumption by the organization. Some embodiments of the present invention may incorporate any or all of the below steps.

Aggregation 200 aggregates lower level records of the same source to create a higher level record of the same source and matches the aggregated record to existing records at that level with a different source. Thus, aggregation 200 involves applying the aggregation rules to create wellbore records from each event source. The first step 20 in aggregation 200 is to aggregate same source events to a wellbore and match multi-source wellbores. In the example of step 20 illustrated in Table 6 below, multiple event level records of the same source are aggregated by applying a set of defined business rules to create a wellbore record of the same source.

TABLE 6
STEP 1—Aggregate Same Source EVENTs into WELLBOREs by Source

| Original UWI (API) | Skey | SOURCE | LEVEL | ACTION | | | Well Government ID | New Ekey | SOURCE | NEW LEVEL |
|---|---|---|---|---|---|---|---|---|---|---|
| 12-123-12345-00-00 | 10001234-000 | STATE | EVENT | \| | Aggregate | -> | 12-123-12345-00 | 10001234-005 | STATE | WELLBORE |
| 12-123-12345-00-00 | 10001234-000 | APC | EVENT | \| | | | Not Aggregate—APC Wellbore already exists for 12-123-12345-00 | | | |
| 12-123-12345-00-00 | 10001234-000 | PI | EVENT | \| | | | | | | |
| 12-123-12345-00-01 | 10001234-001 | PI | EVENT | \| | Aggregate | -> | 12-123-12345-00 | 10001234-005 | PI | WELLBORE |
| 12-123-12345-01-00 | 10001234-002 | APC | EVENT | \| | | | | | | |
| 12-123-12345-01-01 * | 10001234-003 | APC | EVENT | \| | | | | | | |
| 12-123-12345-01-02 * | 10001234-004 | APC | EVENT | \| | Aggregate | -> | 12-123-12345-01 | 10001234-006 | APC | WELLBORE |
| 12-123-12345-01-00 | 10001234-002 | PI | EVENT | \| | Aggregate | -> | 12-123-12345-01 | 10001234-006 | PI | WELLBORE |

Here, a 12-digit API number is created from each source and stored in the well government ID field and the well level type is set to WELLBORE. The EKey column is set to the next component number in sequence for the 8 digit well identifier. It is not necessary to store this new identifier in the well alias table. Note that, in this example, the APC event record 12-123-12345-00-00 is not aggregated because a corresponding wellbore record already exists with a source of APC.

The next step 22 in aggregation 200 is to aggregate same source wellbores to a well and match multi-source wells. Table 7 below is an example of step 22. Here, wellbore records of the same source are aggregated to create well records with that source. Note that the aggregation step in some embodiments includes wellbore records aggregated from events in addition to wellbore records that existed in the source at that level. Additionally, the physical wellbore records must be assigned a matching EKey. At this level in the aggregation process, the EKey will be a simple 8-digit identifier with no component extension.

TABLE 7

| UWI/WELL | | | | | | | Well Government | New | NEW | NEW |
|---|---|---|---|---|---|---|---|---|---|---|
| GOVT ID | Ekey | SOURCE | LEVEL | ACTION | | | ID | Ekey | SOURCE | LEVEL |
| 12-123-12345-00 | 10001234-005 | STATE | WELLBORE | \| | Aggregate | -> | 12-123-12345 | 10001234 | STATE | WELL |
| 12-123-12345-00 | 10001234-005 | APC ** | WELLBORE | \| | | | | | | |
| 12-123-12345-01 | 10001234-006 | APC | WELLBORE | \| | | | Not Aggregated—APC Wellbore already exists for 12-123-12345 | | | |
| 12-123-12345-00 | 10001234-005 | PI | WELLBORE | \| | | | | | | |
| 12-123-12345-01 | 10001234-006 | PI | WELLBORE | \| | Aggregate | -> | 12-123-12345 | 10001234 | PI | WELL |
| 12-123-12345-00 | 10001234-005 | WV | WELLBORE | \| | | | | | | |
| 12-123-12345-01 | 10001234-006 | WV | WELLBORE | \| | Aggregate | -> | 12-123-12345 | 10001234 | WV | WELL |

The last step 24 of aggregation 200 is to populate a well XRef table with new identifiers and relationships. With this approach, maintenance of relationships through the well XRef table becomes very important. An example of a well XRef table is provided below as Table 8. The purpose of aggregation is to create a record at a higher level from records at a lower level; thus, the well XRef table keeps track of which lower level records have been aggregated into the higher level record. In the example of the XRef table provided below, blue cells represent the original sourced records and pink cells represent the aggregated records.

TABLE 8
Well XRef Table
Well Xref

| UWI | XREF_ID | UWI2 | Source * | Xref Type |
|---|---|---|---|---|
| 10001234-005 | 001 | 10001234-000 | STATE | AG_E2WB |
| 10001234-005 | 002 | 10001234-000 | PI | AG_E2WB |
| 10001234-005 | 003 | 10001234-001 | PI | AG_E2WB |
| 10001234-006 | 001 | 10001234-002 | APC | AG_E2WB |
| 10001234-006 | 002 | 10001234-003 | APC | AG_E2WB |
| 10001234-006 | 003 | 10001234-004 | APC | AG_E2WB |
| 10001234-006 | 004 | 10001234-002 | PI | AG_E2WB |
| 10001234 | 001 | 10001234-005 | STATE | AG_WB2W |
| 10001234 | 004 | 10001234-005 | PI | AG_WB2W |
| 10001234 | 005 | 10001234-006 | PI | AG_WB2W |
| 10001234 | 006 | 10001234-005 | WV | AG_WB2W |
| 10001234 | 007 | 10001234-006 | WV | AG_WB2W |

The goal of the well XRef table is to be able to trace back to determine which records were aggregated together and then blended to produce the final versions. Note that with the well XRef table, only aggregated records are included and the XRef type field is set to the level of aggregation.

To track back from a single blended record, identify the records that were used to create the blend and then identify the Aggregate records that were used to create each blend. The well alias table can then be referenced to determine the original UWI.

Following aggregation 200, blending 300 is performed in the Aggregation Method 1. Here, multi-source records are blended to create a single-most-trusted version for presentation to the organization or company.

The first step 30 of blending 300 is to blend multiple source events into blended events. Thus, events with the same UWI number but different source values are blended together to generate a single version or single data point. Thus, the blended events are not used for any further blending or aggregation operations.

As noted previously, the blending process is driven entirely through the Source Preference List (i.e., SPL). Table 9 below illustrates one example of the blending process and results. In the example shown, five distinct events (which are identified by 14-digit numbers in the well government ID field and 11-digit EKeys) are created with attributes promoted according to the SPL shown. In this case, the APC source trumps all other sources of data. In Table 9, blue cells represent the original records and green cells represent the blended records.

TABLE 9
Blending Events

| UWI | Ekey | SOURCE | LEVEL | ACTION | | | Well Government ID | Ekey | NEW SOURCE | NEW LEVEL |
|---|---|---|---|---|---|---|---|---|---|---|
| 12-123-12345-00-00 | 10001234-000 | STATE | EVENT | \| | | | | | | |
| 12-123-12345-00-00 | 10001234-000 | APC | EVENT | \| | | | | | | |
| 12-123-12345-00-00 | 10001234-000 | PI | EVENT | \| | Blend | -> | 12-123-12345-00-00 | 10001234-000 | BLEND | EVENT |
| 12-123-12345-00-01 | 10001234-001 | PI | EVENT | \| | Blend | -> | 12-123-12345-00-01 | 10001234-001 | PI | EVENT |
| 12-123-12345-01-00 | 10001234-002 | APC | EVENT | \| | | | | | | |
| 12-123-12345-01-00 | 10001234-002 | PI | EVENT | \| | Blend | -> | 12-123-12345-01-00 | 10001234-002 | BLEND | EVENT |
| 12-123-12345-01-01 * | 10001234-003 | APC | EVENT | \| | Blend | -> | 12-123-12345-01-01 * | 10001234-003 | APC | EVENT |
| 12-123-12345-01-02 * | 10001234-002 | APC | EVENT | \| | Blend | -> | 12-123-12345-01-02 * | 10001234-004 | APC | EVENT |

The next step 32 is to blend multiple source wellbores into blended wellbores. In Table 10 below, multiple wellbore records with the same well government ID by different source values are blended together to create a blended wellbore, which may include two most-trusted versions. Again, promotion is based upon the associated SPL.

TABLE 10
Blending Wellbores

| UWI/WELL GOVT ID | Ekey | SOURCE | LEVEL | ACTION | | | NEW UWI | Ekey | NEW SOURCE | NEW LEVEL |
|---|---|---|---|---|---|---|---|---|---|---|
| 12-123-12345-00 | 10001234-005 | STATE | WELLBORE | \| | | | | | | |
| 12-123-12345-00 | 10001234-005 | APC ** | WELLBORE | \| | | | | | | |
| 12-123-12345-00 | 10001234-005 | PI | WELLBORE | \| | | | | | | |
| 12-123-12345-00 | 10001234-005 | WV | WELLBORE | \| | Blend | -> | 12-123-12345-00 | 10001234-005 | BLEND | WELLBORE |
| 12-123-12345-01 | 10001234-006 | APC | WELLBORE | \| | | | | | | |
| 12-123-12345-01 | 10001234-006 | PI | WELLBORE | \| | | | | | | |
| 12-123-12345-01 | 10001234-006 | WV | WELLBORE | \| | Blend | -> | 12-123-12345-01 | 10001234-006 | BLEND | WELLBORE |

Finally, the last step 34 of blending 300 is to blend multiple source wells into blended wells. Thus, data from the multiple wells with the same well government ID but different sources are blended into a single well record. The aggregated and physical wellbore records are blended together according to the SPL to create a single-most-trusted well record as illustrated in Table 11 below.

TABLE 11
Blending Wells

| UWI/WELL GOVT ID | Ekey | SOURCE | LEVEL | ACTION | | | NEW UWI | Ekey | NEW SOURCE | NEW LEVEL |
|---|---|---|---|---|---|---|---|---|---|---|
| 12-123-12345 | 10001234 | STATE | WELL | \| | | | | | | |
| 12-123-12345 * | 10001234 | APC ** | WELL | \| | | | | | | |
| 12-123-12345 | 10001234 | DI | WELL | \| | | | | | | |
| 12-123-12345 | 10001234 | PI | WELL | \| | | | | | | |
| 12-123-12345 | 10001234 | WV | WELL | \| | Blend | -> | 12-123-12345 | 10001234 | BLEND | WELL |

Referring now to FIG. 2, the general architecture utilized for one embodiment of the Blending Method 2 is shown. The Blending Method 2 is initiated by blending multiple sourced event records into a single version that can then be aggregated. The Blending Method 2 establishes a multi-level well hierarchy from multiple data sources. The preparation phase 100 is the same as for the Aggregation Method 1. The Blending Method comprises three main phases: preparation 100, event/wellbore 400, and well 500.

The first step 40 of the event/wellbore phase 400 is to blend multiple source events into blended events and write the data to the well XRef table. This step 40 includes blending multi-source events into a single version that is based upon the SPL. In the example illustrated in Table 9 above, three records with a UWI of 10001234-000 are blended together to create a single record with a source equal to BLEND. Once the blending process is complete, the relationship between the new version and the source versions will be written to the well alias table.

The next step 42 of the event/wellbore phase 400 is to aggregate blended events into a wellbore and write the data to the well XRef table. In this step 42 of the process, the application will aggregate wellbore records from blended event records. These records will be assigned a UWI representing the next well component in sequence and matched with existing wellbore records. See the example provided in Table 12 below.

TABLE 12
Aggregating Event Records

| UWI | | SOURCE | LEVEL | ACTION | | | NEW UWI | | NEW SOURCE | NEW LEVEL |
|---|---|---|---|---|---|---|---|---|---|---|
| 12-123-12345-00-00 | 10001234-000 | BLEND | EVENT | \| | | | | | | |
| 12-123-12345-00-01 | 10001324-001 | BLEND | EVENT | \| | Aggregate | -> | 12-123-12345-00 | 100012345-005 | AGGREGATE | WELLBORE |
| 12-123-12345-01-00 | 10001234-002 | BLEND | EVENT | \| | | | | | | |
| 12-123-12345-01-01 | 10001234-003 | BLEND | EVENT | \| | | | | | | |
| 12-123-12345-01-02 | 10001234-004 | BLEND | EVENT | \| | Aggregate | -> | 12-123-12345-01 | 100012345-006 | AGGREGATE | WELLBORE |

Once the aggregating process is complete, the relationship between the new aggregated record and the source versions will be written to the well XRef table.

The last step 44 in the event/wellbore phase 400 is to blend multiple source wellbores into a blended wellbore and write the data to the well XRef table. The multi-source wellbore records will then be blended into a single version based upon the same SPL used for blending event records. See the example provided in Table 13 below.

TABLE 13
Blending Wellbore Records

| | | | | | | | | | NEW |
|---|---|---|---|---|---|---|---|---|---|
| UWI | | SOURCE | LEVEL | ACTION | | | NEW UWI | | SOURCE |
| 12-123-12345-00 | 100012345-005 | AGGREGATE | WELLBORE | \| | | | | | |
| 12-123-12345-00 | 100012345-005 | WV | WELLBORE | \| | | | | | |
| 12-123-12345-00 | 100012345-005 | APC | WELLBORE | \| | Blend | -> | 12-123-12345-00 | 100012345 | BLEND1 |
| 12-123-12345-01 | 100012345-006 | AGGREGATE | WELLBORE | \| | | | | | |
| 12-123-12345-01 | 100012345-006 | WV | WELLBORE | \| | Blend | -> | 12-123-12345-01 | 100012345 | BLEND2 |

| | NEW | Source | Blended | | | | |
|---|---|---|---|---|---|---|---|
| UWI | LEVEL | TD | TD | SPL | Source CD | Agg CD | SPL |
| 12-123-12345-00 | | 8510 | | APC | Jun. 1, 2010 | | APC |
| 12-123-12345-00 | | 8505 | | WV | Jan. 7, 2010 | | WV |
| 12-123-12345-00 | WELLBORE | 8511 | 8511 | APC | Jan. 7, 2010 | Jan. 7, 2010 | APC |
| | | | | AGGREGATE | | | AGGREGATE |
| | | | | PI | | | PI |
| 12-123-12345-01 | | 9000 | | PI | Jan. 15, 2012 | | PI |
| | | | | AGGREGATE | | | AGGREGATE |
| 12-123-12345-01 | WELLBORE | 9005 | 9005 | DI | Jan. 14, 2012 | Jan. 14, 2012 | DI |
| | | | | STATE | | | STATE |

In the example shown in Table 14, a source of APC would take priority over WV, which in turn would take priority over an APC aggregate source. At the end of the process, two wellbores remain with exactly the same parameters as for the Aggregation Method 1. Once the blending process is complete, the relationship between the new version and the source versions will be written to the well alias table.

The first step 50 of the well phase 500 is to aggregate blended wellbores into a blended well and write the data to the well XRef table. In this step of the process, the application will aggregate well records from blended wellbore records. These records will be assigned a UWI representing the 8-digit well identifier and matched with existing well records. See the example shown in Table 14 below.

TABLE 14
Aggregating Wellbore Records

| UWI | | SOURCE | LEVEL | ACTION | | | NEW UWI | |
|---|---|---|---|---|---|---|---|---|
| 12-123-12345-00 | 12-123-12345-0 | BLEND | WELLBORE | \| | | | | |
| 12-123-12345-01 | 12-123-12345-0 | BLEND | WELLBORE | \| | Aggregate | -> | 12-123-12345 | 100012345 |
| | NEW | NEW | Source | Aggregated | Business | | | Business |
| UWI | SOURCE | LEVEL | TD | TD | Rule | Source CD | Agg CD | Rule |
| 12-123-12345-00 | | | 8511 | | | Jan. 7, 2010 | | |
| 12-123-12345-01 | AGGREGATE | WELL | 9005 | 9005 | Select the | Jan. 14, 2012 | Jan. 14, 2012 | Select the |
| | | | | | deepest | | | latest |

Once the aggregating process is complete, the relationship between the new aggregated record and the source versions will be written to the well XRef table.

The last step 52 of the well phase 500 is to blend multiple source wells into a blended well and write the data to the well XRef table. In this step 52, the application will blend multiple well records from different sources into a single version. See the example shown in Table 15 below.

TABLE 15
Blending Well Records

| UWI | | SOURCE | LEVEL | ACTION | | | NEW UWI | |
|---|---|---|---|---|---|---|---|---|
| 12-123-12345 | 100012345 | AGGREGATE | WELL | \| | | | | |
| 12-123-12345 * | 100012345 | APC | WELL | \| | | | | |
| 12-123-12345 | 100012345 | DI | WELL | \| | Blend | -> | 12-123-12345 | 100012345 |
| | NEW | NEW | Source | Blended | | | | |
| UWI | SOURCE | LEVEL | TD | TD | SPL | Source CD | Agg CD | SPL |
| 12-123-12345 | | | 9005 | | APC | Jan. 14, 2012 | | APC |
| 12-123-12345 * | | | 9003 | | WV | Jan. 9, 2010 | | WV |
| 12-123-12345 | BLEND | WELL | 8990 | 9003 | APC | Jan. 7, 2010 | Jan. 9, 2010 | APC |
| | | | | | AGGREGATE | | | AGGREGATE |

With this approach (i.e., the Blending Method 2), the results for the well record match those values generated through the Aggregation Method 1. Once the blending process is complete, the relationship between the new version and the source versions will be written to the well alias table.

In the examples shown in FIGS. 1-2 and Tables 1-15, the same results are achieved with either the Aggregation Method 1 or the Blending Method 2 because adding an APC wellbore or well source record in the later stages of the process overrides the earlier work. However, if these additional records are removed and you focus on 14-digit records, then you get different results. See Table 16 below.

TABLE 16
Comparison of Methods' Results

| | | | | | | NEW | NEW | NEW | Source | Blended | | Source | | Blend |
|---|---|---|---|---|---|---|---|---|---|---|---|---|---|---|
| UWI | SOURCE | LEVEL | ACTION | | | UWI | SOURCE | LEVEL | TD | TD | SPL | CD | | CD |
| 12-12- | STATE- | WELL- | \| | | | | | | 8580 | | APC | Jan. 6, | | |
| 12345- | AG_E2WB | BORE | | | | | | | | | | 2010 | | |
| 00 | | | | | | | | | | | | | | |
| 12-12- | APC- | WELL- | \| | | | | | | 8490 | | WV | Jan. 9, | | |
| 12345- | AG_E2WB | BORE | | | | | | | | | | 2010 | | |
| 00 | ** | | | | | | | | | | | | | |
| 12-12- | PI- | WELL- | \| | | | | | | 8510 | 8490 | APC | Jun. 1, | | Jan. 9, |
| 12345- | AG_E2WB | BORE | | | | | | | | | AGGREGATE | 2010 | | 2010 |
| 00 | | | | | | | | | | | PI | | | |
| 12-12- | APC- | WELL- | \| | | | | | | 9000 | | PI | Jan. 15, | | |
| 12345- | AG_E2WB | BORE | | | | | | | | | AGGREGATE | 2012 | | |
| 01 | | | | | | | | | | | | | | |
| 12-12- | DI- | WELL- | \| | | | | | | 9010 | 9000 | DI | Jan. 31, | | Jan. 15, |
| 12345- | AG_E2WB | BORE | | | | | | | | | | 2011 | | 2012 |
| 01 | | | | | | | | | | | | | | |
| | | | | | | NEW | NEW | NEW | Source | Blended | | Source | Agg | |
| UWI | SOURCE | LEVEL | ACTION | | | UWI | SOURCE | LEVEL | TD | TD | SPL | CD | CD | SPL |
| 12-12- | AGGRE- | WELL- | \| | Blend | -> | 12-12- | BLEND | WELLBORE | 8518 | 8510 | | Jun. 1, | Jun. 1, | |
| 12345- | GATE | BORE | | | | 12345- | | | | | | 2010 | 2010 | |
| 00 | | | | | | 00 | | | | | | | | |
| 12-12- | AGGRE- | WELL- | \| | Blend | -> | 12-12- | BLEND | WELLBORE | 9008 | 9000 | | Jan. 15, | Jan. 15, | |
| 12345- | GATE | BORE | | | | 12345- | | | | | | 2012 | 2012 | |
| 01 | | | | | | 01 | | | | | | | | |

There are different results for the 00 wellbore depending on whether the first approach (Aggregation Method 1) or the second approach (Blending Method 2) is used. See Table 17 below.

TABLE 17
Comparison of Attributes

| 00 Wellbore | TD | Completion Date |
|---|---|---|
| Aggregation Method | 8490 | Jan. 9, 2010 |
| Blending Method | 8510 | Jun. 1, 2010 |

In the Aggregation Method 1, you get the APC TD for the 00 wellbore, which would be expected, but then this method misses the fact that there was a later recompletion on the wellbore because the PI record was of a lower priority than the APC record at the wellbore level. With the Blending Method 2, the PI TD gets promoted over the APC TD because the records were aggregated and the business rule of deepest depth kicked in. The Blending Method 2 promotes the latest completion date for the 0001 event all the way through to the final wellbore record, which is correct.

Looking at the respective workflows for the Aggregation Method 1 and the Blending Method 2, in some embodiments the Aggregation Method 1 is a cleaner solution because all of the aggregation is performed initially, followed by the blending as a final step. While the Blending Method 2 can be achieved in fewer steps, it does mix aggregation and blending steps, which can be more difficult to implement. The biggest differentiator between the two methods, however, is that the Aggregation Method 1 lends itself to being able to trace back to identify the individual records that were involved in generating the final record versions. This is very important. With the Blending Method 2, tracing back to identify individual records is much more complicated and, in some situations, may not be possible. For reasons of simplicity in architecture and implementation and the ability to trace back to identify source records, therefore, the recommended workflow in one embodiment is that defined within the Aggregation Method 1.

One of the main requirements of this process is to link child records back to the final aggregated and blended records that are used for map display and query. Thus, the well version table contains the necessary relationships for blended records while the well XRef table contains the aggregation relationships.

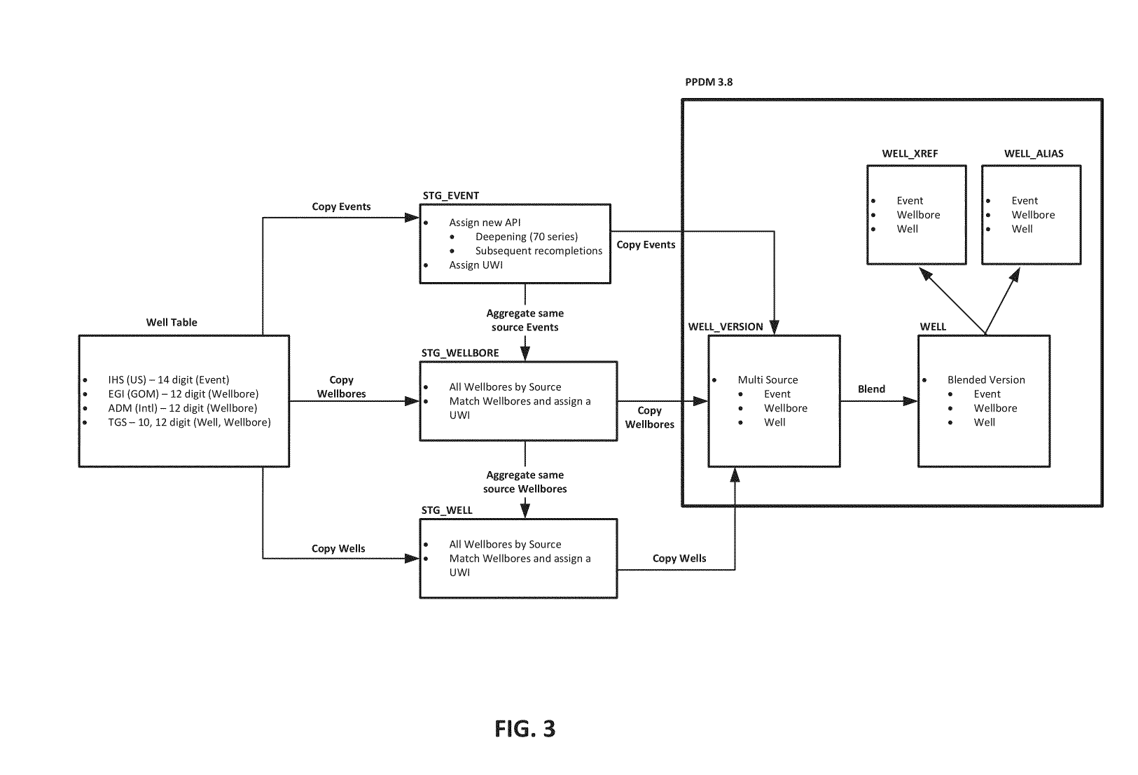

The general architecture for the Aggregation Method is illustrated in FIG. 3. In some embodiments, each table shown or described in FIG. 3 can be a database to record and store information. At a high level, a series of staging tables will be used to prepare the data for loading into a subset of standard PPDM 3.8 tables. PPDM is currently a de-facto industry standard. Version 3.8 of the PPDM is the most recent version being used in industry. However, PPDM 3.9 may also be used or any future version of PPDM may be used. A standard PPDM table refers to a database table within the data model. One or more database functions (i.e., stored procedures) have been developed to coordinate the workflows or methods to minimize or eliminate any manual intervention. The workflow or method may be called to run against the full contents of the well database for a base load or against a single record for a transactional update.

The architecture includes a Technical Database (“TDB”) for wells (also called a “TDB well table”). The TDB contains information from multiple sources for multiple wells at multiple levels. The architecture also includes staging tables. In the example shown, the staging tables include a STG_EVENT table, a STG_WELLBORE table, and a STG_WELL table. Information for events is copied from the TDB to the STG_EVENT table, information for wellbores is copied from the TDB to the STG_WELLBORE table, and information for wells is copied from the TDB to the STG_WELL table. Data and information in each staging table can be aggregated into a staging table of a higher level, e.g., STG_EVENT→STG_WELLBORE, STG_WELLBORE→STG_WELL.

The staging tables provide a working area in which to match and aggregate data prior to delivery of that data to the PPDM 3.8 tables. The staging tables are optional, and the full process can be executed in memory to eliminate the need for transient storage. In some embodiments, the contents of these PPDM 3.8 tables are not permanent; the tables will be cleared out upon completion of the workflows. Thus, it is possible to track the history of the workflow through the contents of the PPDM 3.8 tables without having to maintain the contents of the staging tables.

In embodiments where the staging tables are implemented, the STG_EVENT table is used to match event records from different sources and assign an EKey. The STG_EVENT table assigns a new API number to the events (e.g., deepenings, which get 70-series numbers, and subsequent recompletions) and assigns an UWI to the events. Thus, the STG_EVENT table may process any IHS 14-digit events that are identified as deepenings together with any subsequent events on that wellbore. Since many wellbores have a single event, there is little to be gained by copying these records into the STG_EVENT table and the process could be simplified by copying these event records directly to the well version table or database and aggregating the event records into the wellbore table (i.e., STG_WELLBORE table).

In embodiments where staging tables are implemented, the STG_WELLBORE table is used to match wellbore records from different sources and assign an EKey or UWI to each wellbore record. The wellbore records can be copied from the source in the TDB well table and can also be aggregated from the 14-digit event records in the STG_EVENT table. If a well has a single wellbore, then there is little to be gained by copying these wellbore records into the STG_WELLBORE table and the process could be simplified by copying these wellbore records directly to the well version table or database and aggregating the wellbore records into the well table (i.e., STG_WELL table).

In embodiments where staging tables are implemented, the STG_WELL table can be used to match well records from different sources and assign an EKey, which may be 8-digits, or a UWI. The well records may be copied from the source in the TDB well table and may be aggregated from the 12-digit wellbore record in the STG_WELLBORE table.

Once the different well level records have been aggregated, matched, and assigned an EKey, the records can be copied into the well version table (i.e., the WELL_VERSION table). Thus, data and information in each staging table is copied to the well version table, which can be a database in some embodiments. The well version table includes records from different sources and at different levels in the well hierarchy. From the well version table, all records with a matching EKey and a different source value will be blended from the well version table to the well table (i.e., WELL table) according to the source priorities established in the SPL.

From the well table, data and information is sent or copied to the well XRef table (i.e., WELL_XREF table) and the well alias table (i.e., WELL_ALIAS table).

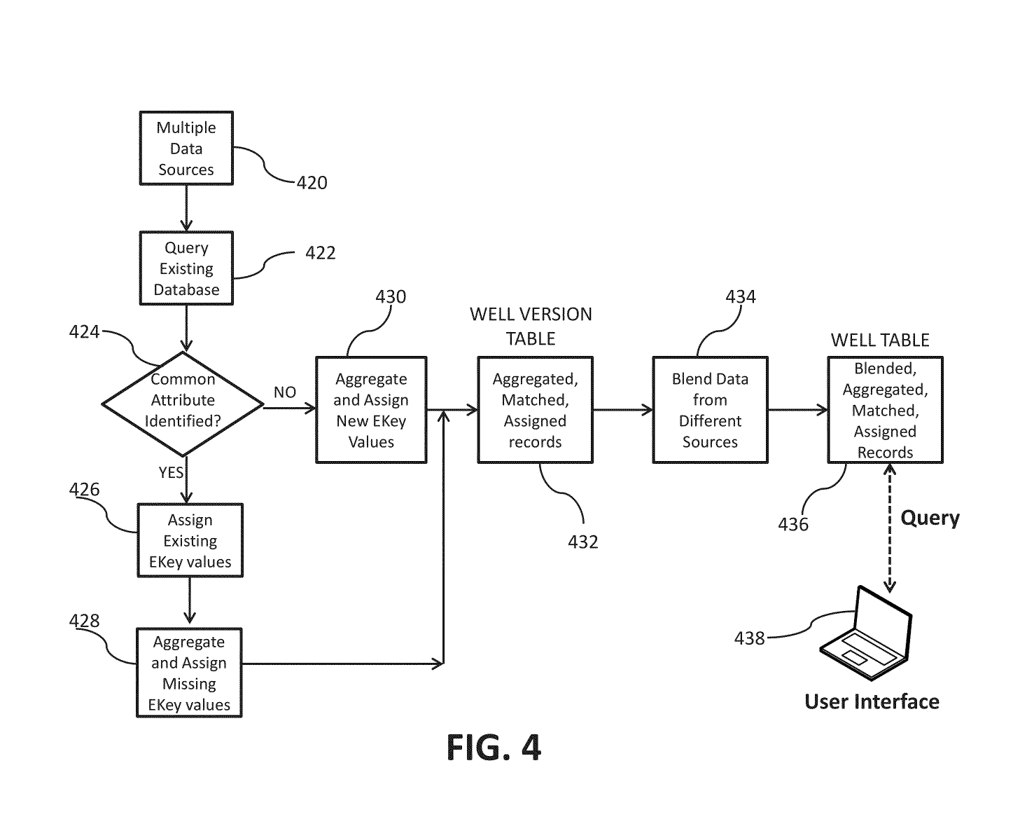

FIG. 4 illustrates an embodiment of a method or system 410 for acquiring, assigning, aggregating, and blending well data from multiple data sources. More specifically, FIG. 4 is a flow chart showing one embodiment of the Aggregation Method for building out the well hierarchy. The method or system 410 begins with step 420, providing multiple data sources with various records for wells, wellbores, and events. Next, existing databases are queried in step 422. Step 424 determines whether a common attribute between one or more records is identified. See the discussion of FIG. 6 below for possible attributes. If a common attribute is not identified, then the method or system 410 proceeds to step 430: aggregate and assign new EKey values to the records. If a common attribute is identified, then the method or system 410 proceeds to step 426: assign existing EKey values to the records with common attributes. Next, the method or system 410 aggregates and assigns missing EKey values to additional records. At this point, step 428 and step 430 both proceed to step 432: providing aggregated, matched, and assigned records to the WELL_VERSION table, and example of which is provided above as Table 12. Next, the data from different sources is blended in step 434. From there, the blended, aggregated, matched, and assigned records are copied to the WELL table, and example of which is provided above as Table 13. Lastly, the user interface 438 can query the WELL table for the records.

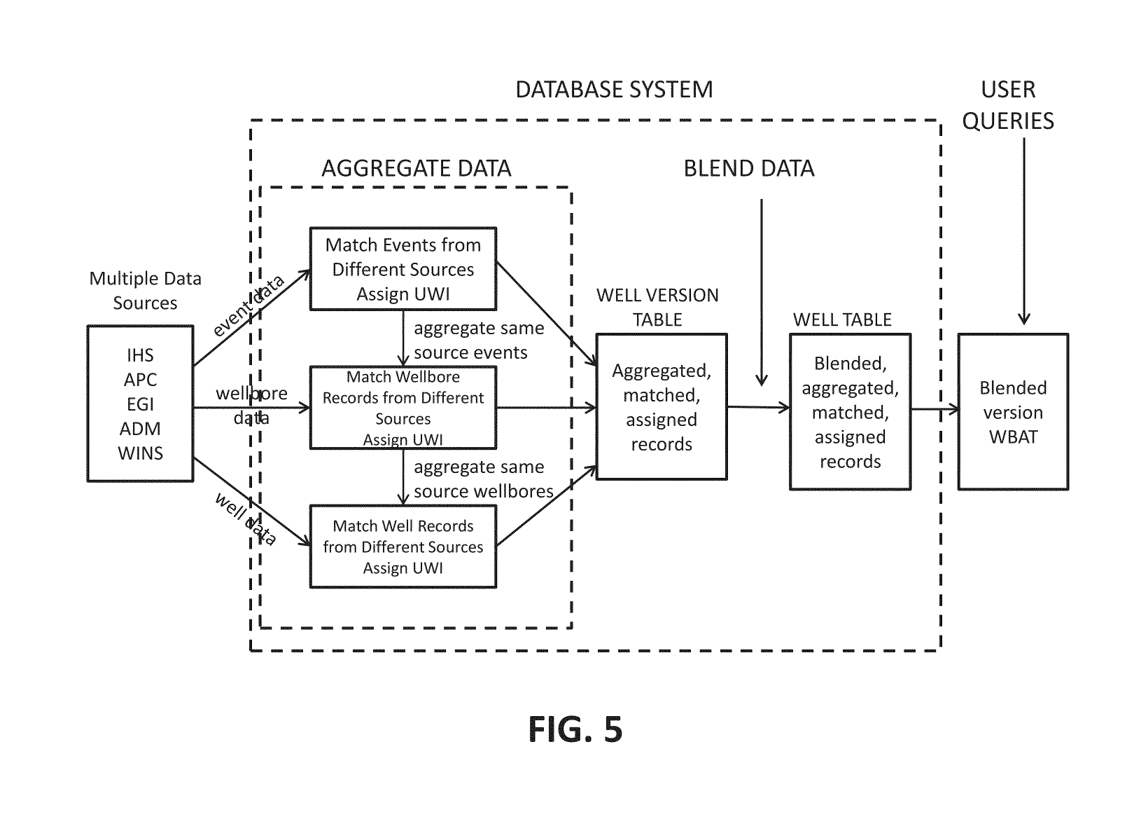

FIG. 5 illustrates a database system according to one embodiment of a method or system for acquiring, assigning, aggregating, and blending well data from multiple data sources. More specifically, FIG. 5 is a physical implementation of the method or system and what is happening within the database. Data from multiple sources (e.g., IHS, APC, EGI, ADM, WINS) is stored in one or more databases. Then, data from the multiple sources is copied or provided to the database system, and specifically to the aggregate data system. The database system comprises an aggregate data system, a first table (i.e., the WELL_VERSION table), which may also be a database, and a second table (i.e., the WELL table), which may also be a database. The aggregate data system comprises one or more databases. For example, the aggregate data system may comprise a database for event data, a database for wellbore data, and a database for well data. Thus, event records (or data) may be provided from the data sources to the event database where the event records from different sources can be matched. Then the matched event records are assigned UWI's. Wellbore records (or data) may be provided from the data sources to the wellbore database where the wellbore records from different sources can be matched. Then the matched wellbore records are assigned UWI's. Additionally, event records from the event database can be aggregated into the wellbore database. Well records (or data) may be provided from the data sources to the well database where the well records from different sources can be matched. Then the matched well records are assigned UWI's. Additionally, wellbore records from the wellbore database can be aggregated into the well database. Next, data or records from the aggregate data system are aggregated, matched, assigned, and provided to a first table in the database system (i.e., the WELL_VERSION table), which may also be a database. Then data or records from the first database are blended and provided or copied to a second table in the database system (i.e., the WELL table), which may also be a database. In some embodiments, the data or records may then be provided to the Wellbore Attributes Table (“WBAT”), which a user can query to get the records. The various source wellbore identifiers are stored within the WBAT table for reference and linkage purposes. In some embodiments, the WBAT is populated from the TDB.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention. However, it is to be expressly understood that such modifications and alterations are within the scope and spirit of the present invention, as set forth in the following claims. Those skilled in the art will appreciate that the conception, upon which this disclosure is based, may readily be utilized as a basis for designing of other structures, methods and systems for carrying out the several purposes of the present invention. It is important, therefore, that the claims be regarded as including any such equivalent construction insofar as they do not depart from the spirit and scope of the present invention. Further, the invention(s) described herein is capable of other embodiments and of being practiced or of being carried out in various ways. It is to be understood that the phraseology and terminology used herein is for the purpose of description and should not be regarded as limiting.

What is claimed is:

1. A method for integrating records from one or more oil and gas well data sources into a multi-level well hierarchy within a database comprising:
a) providing a database of oil and gas well data organized in hierarchical levels that include a well level, a wellbore level, and a low level, wherein the well level is higher than any other level and the wellbore level is below the well level,
wherein the oil and gas well data comprise stored records associated with one of the hierarchical levels,
wherein each stored record comprises an attribute,
wherein each stored record at the wellbore level receives the attribute from one or more stored records at the well level, and
wherein each stored record at the low level receives the attribute from one or more stored records at the wellbore level and the attribute from one or more stored records at the well level;
b) identifying one of the stored records as a deepening event;
c) reclassifying the stored record identified as a deepening event as a wellbore;
d) providing each one of the stored records with a unique identifier including a prefix and a suffix, wherein the prefix denotes data stored at the well level and the suffix denotes data stored at one or more levels lower than the well level in the in the hierarchy;
e) receiving a first new record from a first source of the one or more oil and gas well data sources, wherein the first new record comprises a first attribute, and wherein the first new record is associated with one of the hierarchical levels;
f) locating a second one of the stored records that includes the first attribute, wherein the second one of the stored records includes a unique identifier;
g) identifying the second one of the stored records as the first match of the first new record;
h) assigning the unique identifier of the second one of the stored records to the first new record to create a new matched stored record, wherein the new matched stored record includes the unique identifier of the second one of the stored records, and wherein the new matched stored record is at a first level of the hierarchical levels;
i) creating a new unique identifier for the first new record to create a new unmatched stored record, in the event a match is not located, wherein the new unmatched stored record is at the first level of the hierarchical levels;
j) creating an aggregated record for one level higher than the first level, wherein the aggregated record is created from at least one of the new matched stored record and the new unmatched stored record, and wherein the at least one of the new matched stored record and the new unmatched stored record is from the first source and the aggregated record is from the first source;
k) assigning a second new unique identifier to the aggregated record, wherein the second new unique identifier includes a prefix and a suffix, wherein the prefix of the second new unique identifier is the same as a prefix in the unique identifier of the new matched stored record or the new unmatched stored record, and wherein the suffix of the second new unique identifier is different than a suffix in the unique identifier of the new matched stored record or the new unmatched stored record;
l) repeating steps e) through k) for each new record from each one of oil and gas well data sources;
m) blending a third new record having a third unique identifier, from a second source of the one or more oil and gas well data sources, and from a second level of the hierarchical levels with a first existing stored record having the third unique identifier, from a third source of the one or more oil and gas well data sources, and from the second level of the hierarchical levels to create a blended record; and
n) providing a user interface from which a user can submit a query for a well record and receive a search record comprising all oil and gas well data from all of the one or more oil and gas well data sources that match the query.

2. The method for integrating records from one or more oil and gas well data sources into a multi-level well hierarchy within a database of claim 1, wherein the unique identifier is an EKey comprising an 8-digit prefix and a 3-digit suffix.

3. The method for integrating records from one or more oil and gas well data sources into a multi-level well hierarchy within a database of claim 1, further comprising providing an electronic display for displaying content, a processor, memory, and a communication interface to connect to a communication network.

4. A method for creating and managing a well database comprising:
providing a database comprising a well hierarchy, wherein the well hierarchy comprises a first level, a second level, and a third level, wherein the first level is higher in the well hierarchy than the second level and the third level, and wherein the second level is higher in the well hierarchy than the third level;
providing data comprising:
a first stored record having a first attribute and a first unique identifier, wherein the first stored record is a first type of data;
a second stored record having a second attribute and a second unique identifier, wherein the second stored record is a second type of data;
a third stored record having a third attribute and a third unique identifier, wherein the third stored record is a third type of data;
a fourth stored record having the first attribute and a fourth unique identifier, wherein the fourth stored record is the second type of data; and
a fifth stored record having the second attribute and a fifth unique identifier, wherein the fifth stored record is the third type of data;
storing the data in the database, wherein the first type of data is stored at the first level of the well hierarchy, wherein the second type of data is stored at the second level of the well hierarchy, and wherein the third type of data is stored at the third level of the well hierarchy;
providing a first oil and gas well data source and a second oil and gas well data source;
receiving a first new record from the first oil and gas well data source, wherein the first new record comprises the third attribute, and wherein the first new record is the third type of data;
storing the first new record at the third level of the well hierarchy;
locating a stored record having the third attribute and that is the third type of data, wherein the stored record is the third stored record;
identifying the third stored record as a first match of the first new record;
assigning the third unique identifier of the third stored record to the first new record to create a new matched stored record;
storing the new matched stored record at the third level of the well hierarchy;
receiving a second new record from the second oil and gas well data source, wherein the second new record comprises a fourth attribute, and wherein the second new record is the third type of data;
storing the second new record at the third level of the well hierarchy;
searching for a stored record having the fourth attribute and that is the third type of data;
determining that the stored record having the fourth attribute does not exist;
identifying the second new record as an unmatched record;
creating a new unique identifier;
assigning the new unique identifier to the second new record to create a new unmatched stored record;
storing the new unmatched stored record at the third level of the well hierarchy;
aggregating records from the first oil and gas well data source and of the third type of data to create a first new aggregated record of the second type of data and storing the first new aggregated record at the second level of the well hierarchy;
aggregating records from the second oil and gas well data source and of the third type of data to create a second new aggregated record of the second type of data and storing the second new aggregated record at the second level of the well hierarchy;
aggregating records from the first oil and gas well data source and of the second type of data to create a third new aggregated record of the first type of data and storing the third new aggregated record at the first level of the well hierarchy; and
blending the first new aggregated record and the second new aggregated record to create a new blended record of the second type of data and storing the new blended record at the second level of the well hierarchy.

5. A method for creating and managing a well database comprising:
providing a database comprising a well hierarchy, wherein the well hierarchy comprises multiple levels, wherein each level comprises data of one data type;
providing data comprising stored records, wherein each stored record has a unique identifier and has at least one attribute, wherein each stored record is of one data type;
providing one or more oil and gas well data sources;
receiving new records from the one or more oil and gas well data sources, wherein each new record has at least one attribute and is of one data type;
searching for stored records having attributes that are the same as attributes of the new records and that are the same types of data as the new records, wherein stored records having attributes that are the same as attributes of the new records and that are the same types of data as the new records are matches;
determining whether matches exist for the new records;
assigning any unmatched records new unique identifiers to create new unmatched stored records;
assigning unique identifiers of matching stored record to the matching new records to create new matched stored records;
storing the new unmatched stored records and the new matched stored records in the database;
aggregating new unmatched stored records and new matched stored records from the same oil and gas well data source and of the same type of data to create new aggregated records, wherein the new aggregated records are of a type of data one level higher than the new unmatched stored records and new matched stored records;
storing the new aggregated records in the database at the level higher than the new unmatched stored records and new matched stored records;
blending new aggregated records from different oil and gas well data sources and of the same type of data to create new blended records; and
storing the new blended records at the level of the new aggregated records.
